(19) United States
(12) Patent Application Publication
(10) Pub. No.: US 2006/0050100 A1
(43) Pub. Date: Mar. 9, 2006

(54) Recording head driving device and driving method

(75) Inventors: Yoshinao Kondoh, Kanagawa (JP); Kota Nakayama, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd

(21) Appl. No.: 11/144,271

(22) Filed: Jun. 3, 2005

(30) Foreign Application Priority Data
Sep. 9, 2004 (JP) 2004-262630
Sep. 13, 2004 (JP) 2004-265667
Feb. 21, 2005 (JP) 2005-044741

(51) Int. Cl. B41J 29/393

(52) U.S. Cl. 347/19

(57) ABSTRACT

A recording head driving device and driving method are disclosed. At an inkjet recording head, ejector groups, at which ejectors which respectively eject ink drops are disposed two-dimensionally, constitute units. The units are disposed, with respect to one direction, such that partial regions of end portions of ejector groups disposed at adjacent unit structures mutually overlap one another in a direction orthogonal to the one direction. Driving sections, which drive the ejector groups disposed at the corresponding unit structures on the basis of inputted print data, are provided so as to correspond to the units respectively. When the inkjet recording head is driven, print data, for driving the ejector group is inputted to each of the driving sections. The print data driving the ejector group includes only print data driving ejectors included in a mutually-overlapping region of an ejector group at the unit adjacent to that unit.

### CROSS-REFERENCE TO RELATED APPLICATION

This application claims priority under 35 USC 119 from Japanese Patent Application Nos. 2004-262630, 2004-265667 and 2005-044741, the disclosure of which is incorporated by reference herein.

### BACKGROUND OF THE INVENTION

1. Field of the Invention

The present invention relates to a recording head driving device and driving method, and in particular, to a driving device and a driving method of a recording head which carries out image recording by ejecting liquid drops on the basis of print data which corresponds to image data expressing an image to be recorded.

2. Description of the Related Art

There have conventionally been known inkjet recording devices (so-called inkjet printers) having an ink jet recording head which, by using an actuator structured by a piezoelectric element or the like, changes the volume of (expands or contracts) a pressure generating chamber in which ink is filled, and, due to the change in pressure at the interior of the chamber caused by this change in volume, causes an ink drop to be ejected from the distal end of a nozzle which is formed to communicate with the pressure generating chamber.

The trend toward increasing the printing speeds of inkjet recording devices has strengthened in recent years. To this end, inkjet recording heads have come to be used in which the inkjet recording head is made to be longer, the number of nozzles per inkjet recording head is increased, and the nozzles are disposed so as to be lined-up in the form of a matrix, thereby enabling image formation over a wide region in a shorter period of time.

However, when the inkjet recording head is made longer and the number of nozzles is increased and the nozzles are disposed so as to be lined-up in the form of a matrix in this way, a large number of piezoelectric elements, which are disposed so as to be lined-up in the form of a matrix, are accordingly needed. The large number of piezoelectric elements disposed so as to be lined-up in the form of a matrix are formed by processing, e.g., sandblast processing, a single piezoelectric plate (a piezoelectric material such as a piezoelectric ceramic plate or the like before formation of the piezoelectric elements). Accordingly, as the inkjet recording head is made longer, the piezoelectric plate which forms the piezoelectric elements also is made longer. However, making the piezoelectric plate longer and forming a large number of piezoelectric elements disposed so as to be lined-up in the form of a matrix are difficult in terms of production, which leads to a decrease in yield.

Thus, methods have been proposed of connecting plural piezoelectric element units, at which plural piezoelectric elements are formed, in the direction of the rows of the nozzles, so as to form an elongated structure (see, for example, Patent Document 1: Japanese Patent Application Laid-Open (JP-A) No. 2003-226005, Patent Document 2: JP-A No. 6-255098).

By using such a structure, the large number of piezoelectric elements can be formed so as to be divided over plural piezoelectric plates, and it is therefore possible to prevent a decrease in yield.

However, in the above-described technique which is disclosed in Patent Document 1 and Patent Document 2, portions of the printing regions are made to overlap at piezoelectric element units which are adjacent to one another. Therefore, application of ink drops twice in this overlapping printing region must be avoided, and either one of the piezoelectric elements corresponding to the overlapping printing region of the piezoelectric element units must be driven selectively.

As a conventional technique applied to this end, there is the technique of, in order to eliminate non-uniform density arising at overlapping portions of printing regions due to plural scans, not printing the print data which drives the ejectors (the ink drop ejecting portions) corresponding to the overlapping portion, and correcting the print data to a state in which the gradation is changed (see, for example, Patent Document 3: JP-A No. 6-47925, Patent Document 4: JP-A No. 8-106520).

The double application of ink drops at the overlap portion can be avoided by applying this technique to an inkjet recording head which is elongated by connecting plural piezoelectric element units, as a technique for correcting the print data for driving the ejectors corresponding to the overlap portion of the printing regions of adjacent piezoelectric element units.

In the above-described technique of correcting the print data for driving the ejectors corresponding to the overlap portion of the printing regions of adjacent piezoelectric element units, the printing speed decreases because time is needed to correct the print data.

The greater the number of piezoelectric element units which are disposed at the inkjet recording head in order to make the inkjet recording head longer, the more the number of junctures between the respective piezoelectric element units. Therefore, a more serious problem arises, and it is not possible to sufficiently make the best use of the advantage of increasing the printing speed by making the inkjet recording head longer.

### SUMMARY OF THE INVENTION

A recording head driving device and driving method, which can prevent a decrease in the printing speed of a recording head structured by plural ejector groups being lined-up in a state in which portions thereof overlap one another, which decrease is due to the junctures of the ejector groups, are desired.

A first aspect of the present invention is a driving device of a recording head in which plural ejector groups, at which plural ejectors which respectively eject liquid drops are disposed two-dimensionally, are disposed, with respect to a predetermined one direction, in a state in which a partial region of at least one end portion of each of the ejector groups, and a partial region of an end portion of an adjacent ejector group, mutually overlap one another in a direction orthogonal to the one direction. The driving device has: plural driving circuits provided so as to correspond to the ejector groups respectively, the driving circuits driving the corresponding ejector groups on the basis of inputted print data; and a data inputting section inputting, to each of plural driving circuits, print data for driving the corresponding ejector group, in a state in which the print data driving the corresponding ejector group includes only print data driving ejectors which are included in a mutually-overlapping region of an ejector group adjacent to that ejector group.

The driving device of a recording head of the first aspect of the present invention drives a recording head in which plural ejector groups, at which plural ejectors which respectively eject liquid drops are disposed two-dimensionally, are disposed, with respect to a predetermined one direction, in a state in which a partial region of at least one end portion of each of the ejector groups, and a partial region of an end portion of an adjacent ejector group, overlap one another in a direction orthogonal to the one direction.

In the driving device relating to the present invention, corresponding ejector groups are driven, on the basis of inputted print data, by plural driving circuits which are provided so as to correspond to the ejector groups respectively.

In this way, in the driving device of the present invention, because a driving circuit is provided for each of the ejector groups, the driving of the ejectors disposed at the respective ejector groups can be carried out dispersedly by the respective driving circuits, and the printing speed can be increased.

In the driving device relating to the present invention, the print data for driving the corresponding ejector group is inputted by the data inputting section to each of the driving circuits, in a state in which the print data driving the corresponding ejector group includes only print data driving ejectors which are included in a mutually-overlapping region of an ejector group adjacent to that ejector group.

In the print data in this state, the configuration of the image expressed by the print data is rectangular. Therefore, even in a case in which the configuration of the overlapping region of the ejector group, which corresponds to the driving circuit to which that print data is inputted, and the ejector group adjacent to that ejector group, is not rectangular, the print data can be inputted without applying thereto correction corresponding to the configuration of that overlapping region, and the time required for input of the print data can be shortened.

The data length of the print data can be shortened, as compared with a case of inputting all of the print data for both the ejector group corresponding to the driving circuit to which the print data is inputted and the ejector group adjacent to that ejector group. For this reason as well, the time required for input of the print data can be shortened.

The driving circuit, to which the print data is inputted by the data inputting section, drives the ejectors by using only the print data for driving the ejectors belonging to the ejector group to which that driving circuit corresponds. The image which is to be printed by that ejector group can thereby be printed.

In this way, in accordance with the driving device of a recording head of the first aspect of the present invention, plural driving circuits, which drive corresponding ejector groups on the basis of inputted print data when driving a recording head in which plural ejector groups, at which plural ejectors which respectively eject liquid drops are disposed two-dimensionally, are disposed, with respect to a predetermined one direction, in a state in which a partial region of at least one end portion of each of the ejector groups, and a partial region of an end portion of an adjacent ejector group, overlap one another in a direction orthogonal to the one direction, are provided so as to correspond respectively to plural ejector groups, and print data for driving the corresponding ejector group is inputted to each of plural driving circuits, in a state in which the print data driving the corresponding ejector group contains only print data which drives ejectors which are included in a mutually-overlapping region of an ejector group adjacent to that ejector group. Therefore, it is possible to prevent a decrease in the printing speed of the recording head due to junctures of the ejector groups.

A second aspect of the present invention is a driving device of a recording head in which plural unit structures, which have ejector groups at which plural ejectors which respectively eject liquid drops are disposed two-dimensionally, are disposed, with respect to a predetermined one direction, in a state in which a partial region of at least one end portion of the ejector group, and a partial region of an end portion of an ejector group of an adjacent unit structure, mutually overlap one another in a direction orthogonal to the one direction. The driving device has: plural driving circuits provided so as to correspond to the unit structures respectively, the driving circuits driving the ejector groups of the corresponding unit structures on the basis of inputted print data; a data inputting section serially inputting, to each of plural driving circuits and as the print data, print data which is such that an image to be recorded is substantially rectangular and which includes print data driving all of the ejectors disposed at the corresponding unit structure; and a masking section which, of the print data inputted to the respective driving circuits by the data inputting section, masks the print data driving ejectors other than ejectors disposed at the corresponding unit structure.

The driving device of a recording head of the second aspect of the present invention drives a recording head in which plural unit structures having ejector groups, at which plural ejectors which respectively eject liquid drops are disposed two-dimensionally, are disposed, with respect to a predetermined one direction, in a state in which a partial region of at least one end portion of the ejector group, and a partial region of an end portion of an ejector group of an adjacent unit structure, overlap one another in a direction orthogonal to the one direction.

In the driving device relating to the present invention, the ejector groups of the corresponding unit structures are driven, on the basis of inputted print data, by plural driving circuits which are provided so as to correspond to the unit structures respectively.

In this way, in the driving device of the present invention, because a driving circuit is provided for each of the unit structures, the driving of the ejectors disposed at the respective unit structures can be carried out dispersedly by the respective driving circuits, and the printing speed can be increased.

Here, in the driving device of the present invention, print data, which is such that an image to be recorded is substantially rectangular and which includes print data that drives all of the ejectors disposed at the corresponding unit structure, is serially inputted as the print data to each of plural driving circuits by the data inputting section.

In this way, in the driving device of the present invention, the print data which is inputted to each driving circuit is print data which is such that the configuration of the image expressed by that print data is substantially rectangular. Therefore, even in a case in which the configuration of the overlapping region of the unit structure, which corresponds to the driving circuit to which that print data is inputted, and the unit structure adjacent to that unit structure, is not substantially rectangular, the print data can be inputted without applying thereto correction corresponding to the configuration of that overlapping region, and the time required for input of the print data can be shortened.

Further, in the present invention, of the print data inputted to each of plural driving circuits by the data inputting section, the print data, which drives ejectors other than ejectors disposed at the corresponding unit structure, is masked by the masking section. Here, the print data which is the object of masking is fixedly determined in advance. Therefore, the masking of that print data by the masking section can be carried out easily and in a short period of time.

In this way, in accordance with the driving device of a recording head of the second aspect of the present invention, plural driving circuits, which drive the ejector groups of the corresponding unit structures on the basis of inputted print data when driving a recording head in which plural unit structures having ejector groups, at which plural ejectors which respectively eject liquid drops are disposed two-dimensionally, are disposed, with respect to a predetermined one direction, in a state in which a partial region of at least one end portion of an ejector group, and a partial region of an end portion of an ejector group of an adjacent unit structure, overlap one another in a direction orthogonal to the one direction, are provided so as to correspond respectively to the unit structures, and print data, which is such that an image to be recorded is substantially rectangular and which includes print data driving all of the ejectors disposed at the corresponding unit structure, is serially inputted as the print data to each of plural driving circuits, in a state in which the print data, which drives the ejectors other than the ejectors disposed at the corresponding unit structure, are masked. Therefore, it is possible to prevent a decrease in the printing speed of the recording head due to junctures of the ejector groups.

A third aspect of the present invention is a driving method of a recording head in which plural ejector groups, at which plural ejectors which respectively eject liquid drops are disposed two-dimensionally, are disposed, with respect to a predetermined one direction, in a state in which a partial region of at least one end portion of each of the ejector groups, and a partial region of an end portion of an adjacent ejector group, mutually overlap one another in a direction orthogonal to the one direction. The driving method includes: providing plural driving circuits, which drive corresponding ejector groups on the basis of inputted print data, in correspondence with the respective ejector groups; and inputting, to each of plural driving circuits, print data for driving the corresponding ejector group, in a state in which the print data driving the corresponding ejector group includes only print data driving ejectors which are included in a mutually-overlapping region of an ejector group adjacent to that ejector group.

Accordingly, in accordance with the driving method of a recording head of the third aspect, it is possible to prevent a decrease in the printing speed of the recording head due to junctures of the ejector groups.

A fourth aspect of the present invention is a driving method of a recording head in which plural unit structures, which have ejector groups at which plural ejectors which respectively eject liquid drops are disposed two-dimensionally, are disposed, with respect to a predetermined one direction, in a state in which a partial region of at least one end portion of the ejector group, and a partial region of an end portion of an ejector group of an adjacent unit structure, mutually overlap one another in a direction orthogonal to the one direction. The driving method includes: providing plural driving circuits, which drive ejector groups of corresponding unit structures on the basis of inputted print data, in correspondence with the respective unit structures; and serially inputting, to each of plural driving circuits and as the print data, print data which is such that an image to be recorded is substantially rectangular and which includes print data driving all of the ejectors disposed at the corresponding unit structure, in a state in which print data, which drives ejectors other than the ejectors disposed at the corresponding unit structure, are masked.

Accordingly, in accordance with the driving method of a recording head of the fourth aspect, it is possible to prevent a decrease in the printing speed of the recording head due to junctures of the ejector groups.

As described above, in accordance with the present invention, plural driving circuits, which drive corresponding ejector groups on the basis of inputted print data when driving a recording head in which plural ejector groups, at which plural ejectors which respectively eject liquid drops are disposed two-dimensionally, are disposed, with respect to a predetermined one direction, in a state in which a partial region of at least one end portion of each of the ejector groups, and a partial region of an end portion of an adjacent ejector group, overlap one another in a direction orthogonal to the one direction, are provided so as to correspond respectively to plural ejector groups, and print data for driving the corresponding ejector group is inputted to each of plural driving circuits, in a state in which the print data driving the corresponding ejector group contains only print data which drives ejectors which are included in a mutually-overlapping region of an ejector group adjacent to that ejector group. Therefore, the present invention has the excellent effect that it is possible to prevent a decrease in the printing speed of the recording head due to junctures of the ejector groups.

Further, in accordance with the present invention, plural driving circuits, which drive the ejector groups of the corresponding unit structures on the basis of inputted print data when driving a recording head in which plural unit structures having ejector groups, at which plural ejectors which respectively eject liquid drops are disposed two-dimensionally, are disposed, with respect to a predetermined one direction, in a state in which a partial region of at least one end portion of an ejector group, and a partial region of an end portion of an ejector group of an adjacent unit structure, overlap one another in a direction orthogonal to the one direction, are provided so as to correspond respectively to the unit structures, and print data, which is such that an image to be recorded is substantially rectangular and which includes print data driving all of the ejectors disposed at the corresponding unit structure, is serially inputted as the print data to each of plural driving circuits, in a state in which the print data, which drives the ejectors other than the ejectors disposed at the corresponding unit structure, are masked. Therefore, the present invention has the excellent effect that it is possible to prevent a decrease in the printing speed of the recording head due to junctures of the ejector groups.

### BRIEF DESCRIPTION OF THE DRAWINGS

Embodiments of the present invention will be described in detail based on the following figures, wherein:

FIG. 1 is a schematic diagram showing main structures of an inkjet recording device relating to a first embodiment;

FIG. 2 is a plan view showing the schematic structure of an inkjet recording head relating to the first embodiment;

FIG. 3 is a block diagram (a partial circuit diagram) showing main structures of a driving IC relating to the embodiments;

FIG. 4 is a circuit diagram showing the structure of a level shifter relating to the embodiments;

FIGS. 5A, 5B and 5C are waveform diagrams showing an example of a driving waveform relating to the embodiments, and examples of an output waveform of a first signal generating circuit alone and an output waveform of a second signal generating circuit alone which are needed in order to generate the driving waveform;

FIG. 6 is a block diagram showing the structure of a section of a controller relating to the first embodiment, which section relates to the generation of a clock signal;

FIGS. 7A and 7B are schematic diagrams showing states of output timings of print data and mask data relating to the first embodiment;

FIG. 8 is a schematic diagram showing states of the print data and the mask data relating to the first embodiment, and states of data transfer of the print data at shift registers in two driving ICs corresponding to adjacent unit structures (ejector groups);

FIG. 9 is a flowchart showing the flow of processings of a printing processing program relating to the first embodiment;

FIG. 10 is a diagram used for explaining the printing processing program relating to the first embodiment, and is a schematic diagram showing the transition of the state of the print data;

FIG. 11 is a diagram used for explaining the printing processing program relating to the first embodiment, and is a schematic diagram showing the transition of the state of the print data;

FIG. 12 is a plan view showing the schematic structure of a modified example of the inkjet recording head relating to the first embodiment;

FIG. 13 is a diagram used for explaining the printing processing program in a case in which the inkjet recording head shown in FIG. 12 is applied, and is a schematic diagram showing the transition of the state of the print data;

FIG. 14 is a diagram used for explaining the printing processing program in a case in which the inkjet recording head shown in FIG. 12 is applied, and is a schematic diagram showing the transition of the state of the print data;

FIGS. 15A, 15B and 15C are waveform diagrams showing examples of waveform signals inputted to a driving waveform generating circuit of a driving IC relating to the embodiments, and driving waveforms generated by these waveform signals;

FIG. 16 is a schematic diagram showing main structures of inkjet recording devices relating to second through fifth embodiments;

FIG. 17 is a plan view showing the schematic structures of inkjet recording heads relating to the second through fourth embodiments;

FIG. 18 is a block diagram showing main structures of a controller relating to the second embodiment;

FIG. 19 is a flowchart showing the flow of processings of a printing processing program relating to the second through fifth embodiments;

FIG. 20 is a timing chart showing specific examples of generated states of clock signals supplied to respective driving ICs at the controller relating to the second embodiment, and states of print data taken-in by the respective driving ICs;

FIG. 21 is a block diagram (a partial circuit diagram) showing main structures of a driving IC relating to the third and fourth embodiments;

FIG. 22 is a block diagram showing main structures of a controller relating to the third embodiment;

FIG. 23 is a timing chart showing specific examples of generated states of clock signals supplied to respective driving ICs at the controller relating to the third embodiment, and states of print data taken-in by the respective driving ICs;

FIG. 24 is a block diagram showing main structures of a controller relating to the fourth embodiment;

FIG. 25 is a timing chart showing specific examples of generated states of clock signals supplied to respective driving ICs at the controller relating to the fourth embodiment, and states of print data taken-in by the respective driving ICs;

FIG. 26 is a plan view showing the schematic structure of an inkjet recording head relating to the fifth embodiment;

FIG. 27 is a block diagram showing main structures of a controller relating to the fifth embodiment; and

FIG. 28 is a timing chart showing specific examples of generated states of clock signals supplied to respective driving ICs at the controller relating to the fifth embodiment, and states of print data taken-in by the respective driving ICs.

### DETAILED DESCRIPTION OF THE INVENTION

Embodiments of the present invention will be described in detail hereinafter with reference to the drawings.

### First Embodiment

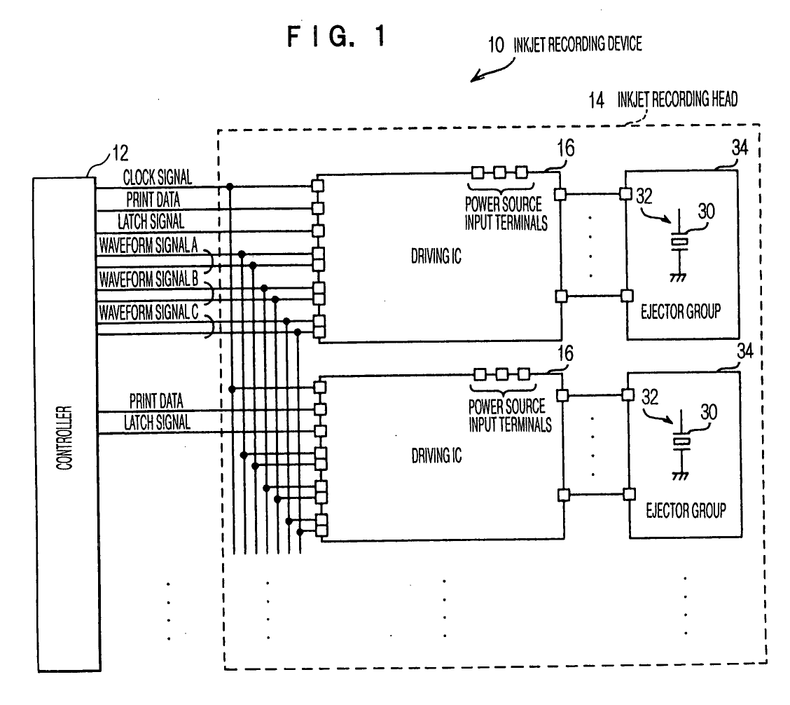

First, the structure of an inkjet recording device 10 relating to the present embodiment will be described with reference to FIGS. 1 through 8.

FIG. 1 is a diagram showing main structures of the inkjet recording device 10 relating to the present embodiment. Mainly the structures at the periphery of the inkjet recording head, except for a recording sheet conveying system, are illustrated in FIG. 1.

As shown in FIG. 1, the inkjet recording device 10 relating to the present embodiment has a controller 12 (an example of a data inputting section), which governs the operations of the entire inkjet recording device 10, and an inkjet recording head 14, which ejects ink drops on the basis of supplied print data. The inkjet recording head 14 has plural ejector groups 34 and driving ICs (Integrated Circuits) 16. The ejector groups 34 are structured such that plural ejectors 32 are arranged two-dimensionally. The ejectors 32 eject ink drops due to the deformation of piezoelectric elements (piezo elements) 30 provided individually thereat. The driving ICs 16 are provided so as to correspond to the ejector groups 34 respectively.

The inkjet recording head 14 relating to the present embodiment is an elongated structure whose width is substantially equal to the width of a recording sheet. Namely, the present inkjet recording device 10 is structured as a so-called FWA (Full-Width Array) type inkjet recording device which carries out recording while conveying only the recording sheet with the inkjet recording head 14 remaining fixed.

The ejector 32 relating to the present embodiment is structured so as to include: a pressure generating chamber in which ink is filled; an ink ejecting opening which communicates with the pressure generating chamber and which can eject ink; and an actuator which has a vibrating plate structuring a portion of a wall surface of the pressure generating chamber and expanding or contracting the pressure generating chamber by vibrating, and has the piezoelectric element 30 which vibrates the vibrating plate by deforming by voltage applied thereto in accordance with image data expressing the image to be recorded.

All of the driving ICs 16 provided at the inkjet recording head 14 are connected to the controller 12. The control of the operations of the driving ICs 16 is carried out by the controller 12 by using clock signals, print data, and latch signals, as well as a waveform signal A, a waveform signal B and a waveform signal C, each of which is a pair of signals, and the like.

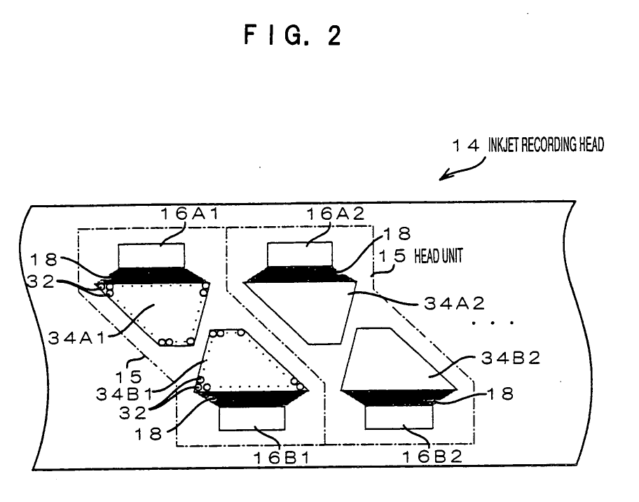

A plan view showing the schematic structure of the inkjet recording head 14 relating to the present embodiment is shown in FIG. 2.

As shown in FIG. 2, at the inkjet recording head 14 relating to the present embodiment, each of ejector groups 34A1, 34B1, 34A2, 34B2, . . . , which is structured by plural the ejectors 32 being arranged two-dimensionally, is a unit structure. The plural unit structures are disposed, with respect to a predetermined one direction (the longitudinal direction (elongated direction) of the inkjet recording head 14), such that partial regions at the end portions of the ejector groups which are disposed at adjacent unit structures, overlap one another.

The driving ICs 16A1, 16B1, 16A2, 16B2 . . . are provided individually in a one-to-one correspondence with the ejector groups 34A1, 34B1, 34A2, 34B2, . . . . The ejector group and the corresponding driving IC are electrically connected by a connecting wire 18. Hereinafter, the ejector groups 34A1, 34B1, 34A2, 34B2, . . . may be abbreviated as “the ejector group 34”, other than in cases of designating a specific ejector group. Further, hereinafter, the driving ICs 16A1, 16B1, 16A2, 16B2 . . . may be abbreviated as “the driving IC 16”, other than in cases of designating a specific driving IC.

The configuration of the region where the ejector group 34 relating to the present embodiment is disposed is a trapezoidal configuration in which the angles of the two inclined sides connecting the top side and the floor side are different from one another. Further, in the inkjet recording head 14 relating to the present embodiment, a pair of the ejector groups 34 structure a head unit 15 as a unit part, due to the respective floor sides of the pair of ejector groups 34 being disposed so as to oppose one another across a longitudinal direction central line of the inkjet recording head 14, and the corresponding ICs 16 being disposed integrally therewith. The inkjet recording head 14 is structured in a state in which plural these head units 15 are lined-up in the longitudinal direction.

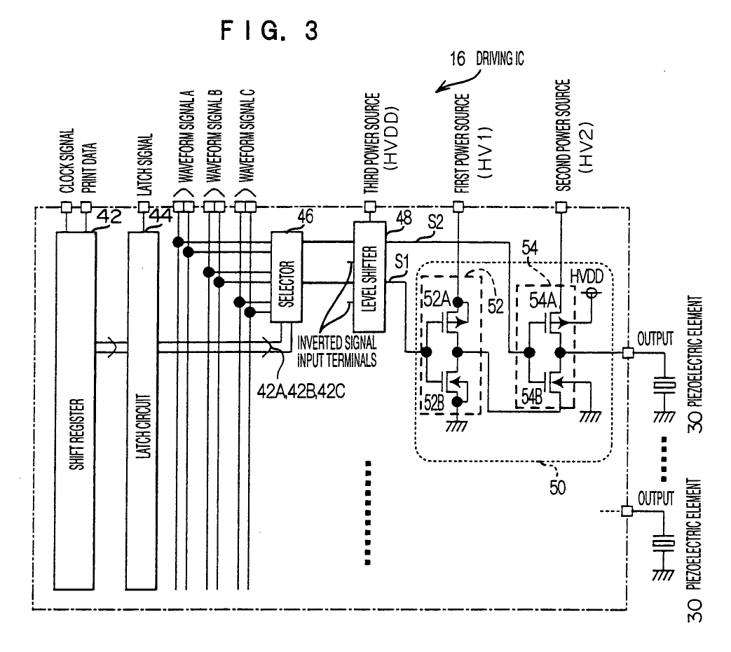

The structure of the driving IC 16 relating to the present embodiment is shown in FIG. 3.

As shown in FIG. 3, the driving IC 16 relating to the present embodiment has a shift register 42, a latch circuit 44, a selector 46, a level shifter 48, and a driving waveform generating circuit 50.

A clock signal and print data outputted from the controller 12 are inputted to the shift register 42, and a latch signal is inputted to the latch circuit 44.

The print data selects one (of the pair of signals) of the waveform signal A, the waveform signal B and the waveform signal C, and the print data is serial data formed from a waveform signal A selecting signal 42A, a waveform signal B selecting signal 42B, and a waveform signal C selecting signal 42C. The waveform signal A selecting signal 42A, the waveform signal B selecting signal 42B, and the waveform signal C selecting signal 42C are each a signal expressing one bit data which is “0” or “1”. The waveform signal A selecting signal 42A is a signal which is “1” when the waveform signal A is selected, and is “0” when the waveform signal A is not selected. The waveform signal B selecting signal 42B is a signal which is “1” when the waveform signal B is selected, and is “0” when the waveform signal B is not selected. The waveform signal C selecting signal 42C is a signal which is “1” when the waveform signal C is selected, and is “0” when the waveform signal C is not selected.

Namely, the print data is 3-bit serial data, which is “100” when the waveform signal A is selected, “010” when the waveform signal B is selected, and “001” when the waveform signal C is selected. This print data is inputted to the shift register 42 continuously a number of times which is the sum of the number of ejectors 32, which are included in the corresponding ejector group 34, and the numbers of ejectors 32, of the adjacently-disposed ejector groups 34 which ejectors 32 overlap in the short side direction of the inkjet recording head 14.

Note that, hereinafter, explanation will be given of a case in which a driving waveform is supplied to a single piezoelectric element 30. However, the same holds for the other piezoelectric elements 30 as well, and therefore, description relating to these other piezoelectric elements 30 will be omitted.

The shift register 42 converts the inputted print data, which is the 3-bit serial data, into 3-bit parallel data, and outputs the parallel data to the latch circuit 44.

In accordance with the input of a latch signal, the latch circuit 44 latches (self-holds) the parallel data outputted from the shift register 42.

The waveform signal A, the waveform signal B, and the waveform signal C are inputted from the controller 12 to the selector 46 as object-of-selection signals, and the parallel data of the print data latched by the latch circuit 44 is inputted to a select terminal. Accordingly, the selector 46 selects, from among the waveform signal A, the waveform signal B, and the waveform signal C, the waveform signal for which selection is instructed by the print data, and outputs the selected waveform signal.

The waveform signal output terminal of the selector 46 is connected to the level shifter 48. The waveform signal outputted from the selector 46 is level-converted and outputted by the level shifter 48. Note that electric power of a predetermined voltage level (a predetermined level exceeding 40V in the present embodiment) HVDD is supplied to the level shifter 48 from a third power source (not shown). The level shifter 48 level-converts the waveform signal selected by the print data to a voltage level corresponding to the voltage level HVDD.

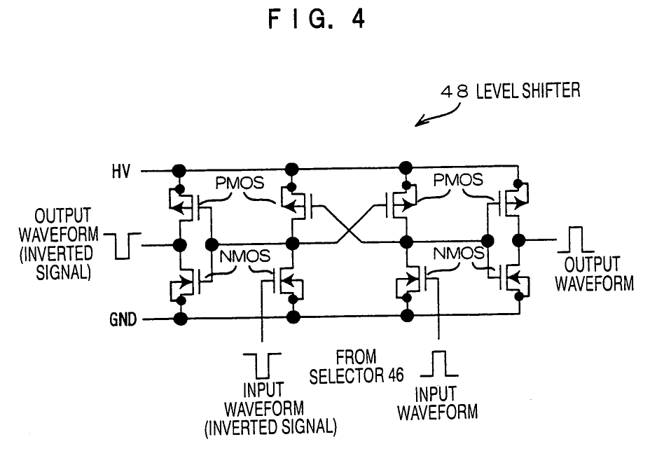

A conventionally-known structure can be used as the level shifter 48. However, in the present embodiment, the circuit structure shown in FIG. 4 using four groups of series circuits formed by P-channel MOS FETs (hereinafter, “PMOS”) and N-channel MOS FETs (hereinafter, “NMOS”) is used as the level shifter 48. Note that the circuit shown in FIG. 4 corresponds to one of the pair of waveform signals inputted from the selector 46. Therefore, two of these circuits are actually required. Further, the circuit shown in FIG. 4 can also handle level conversion of the signal obtained by inverting that one waveform signal, but this portion is not used in the present embodiment.

As shown in FIG. 3, the driving waveform generating circuit 50 relating to the present embodiment has a first signal generating circuit 52 and a second signal generating circuit 54.

The first signal generating circuit 52 relating to the present embodiment is structured as an inverter circuit structured connecting in series a PMOS 52A and an NMOS 52B. Similarly, the second signal generating circuit 54 is structured as an inverter circuit structured by connecting in series a PMOS 54A and an NMOS 54B.

Namely, the drains of the PMOS 52A and the NMOS 52B are connected to one another, and the gates of the PMOS 52A and the NMOS 52B are connected. Similarly, at the second signal generating circuit 54 as well, the drains of the PMOS 54A and the NMOS 54B are connected to one another, and the gates of the PMOS 54A and the NMOS 54B are connected.

Here, electric power which is a predetermined voltage level HV1 (in the present embodiment, a predetermined level within the range of from 10V to 30V) from a first power source (not shown) is supplied to the source of the PMOS 52A of the first signal generating circuit 52. The source of the NMOS 52B is earthed, and is ground level. Further, one output terminal of the level shifter 48 is connected to respective gates of the PMOS 52A and the NMOS 52B. A waveform signal S1, which is one of the pair of waveform signals selected by the selector 46 and which is level-converted by the level shifter 48, is inputted thereto.

Accordingly, at the first signal generating circuit 52, when the signal level of the waveform signal S1 inputted from the level shifter 48 is high level, the PMOS 52A is off and the NMOS 52B is on. Therefore, the voltage level of the outputted voltage is ground level. In contrast, when the signal level of the waveform signal S1 inputted from the level shifter 48 is low level, the PMOS 52A is on and the NMOS 52B is off. Therefore, the voltage level of the outputted voltage is voltage level HV1. As a result, the waveform of the voltage outputted from the first signal generating circuit 52 is the same as the inverted waveform of the waveform signal S1 inputted from the level shifter 48, and the voltage outputted from the first signal generating circuit 52 has two voltage levels which are ground level and the voltage level HV1.

Electric power which is a predetermined voltage level HV2 (in the present embodiment, a predetermined level within the range of from 20V to 40V) from a second power source (not shown) is supplied to the source of the PMOS 54A of the second signal generating circuit 54. The connection point (drain) of the PMOS 52A and the NMOS 52B at the first signal generating circuit 52 is connected to the source of the NMOS 54B. Accordingly, the inverter output of the first signal generating circuit 52 is applied to the source of the NMOS 54B. Further, the other output terminal of the level shifter 48 is connected to respective gates of the PMOS 54A and the NMOS 54B. A waveform signal S2, which is the other of the pair of waveform signals selected by the selector 46 and which is level-converted by the level shifter 48, is inputted thereto.

Accordingly, at the second signal generating circuit 54, when the signal level of the waveform signal S2 inputted from the level shifter 48 is high level, the PMOS 54A is off and the NMOS 54B is on. Therefore, the voltage level of the outputted voltage (i.e., the driving waveform) is the same as the voltage outputted from the first signal generating circuit 52 (the waveform is the same as the inverted waveform of the waveform signal S1 inputted from the level shifter 48, and the voltage has two voltage levels which are the ground level and the voltage level HV1). In contrast, when the signal level of the waveform signal S2 inputted from the level shifter 48 is low level, the PMOS 54A is on and the NMOS 54B is off. Therefore, the voltage level of the outputted voltage (the driving waveform) is voltage level HV2. As a result, the voltage (driving waveform) outputted from the second signal generating circuit 54 is a combination of the voltages which are outputted respectively from the first signal generating circuit 52 and the second signal generating circuit 54 in accordance with the pair of waveform signals S1, S2 inputted from the level shifter 48, and has three voltage levels which are ground level, the voltage level HV1, and the voltage level HV2.

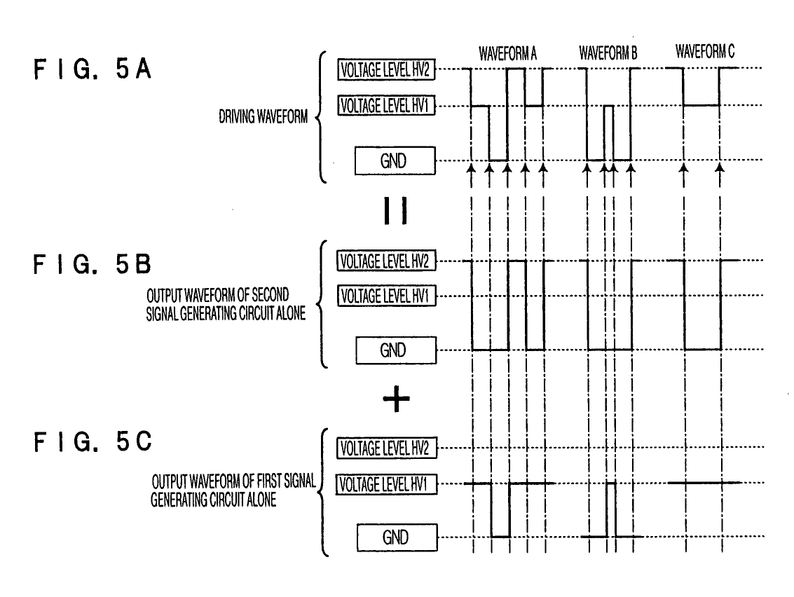

FIG. 5 shows an example of a driving waveform applied to the piezoelectric element 30, and examples of an output waveform of the first signal generating circuit 52 alone and an output waveform of the second signal generating circuit 54 alone which are needed in order to generate that driving waveform.

As shown in FIG. 5, when it is desired to make the voltage level of the driving waveform the voltage level HV2, the voltage level of the output waveform from the second signal generating circuit 54 is made to be the voltage level HV2. Accordingly, in this case, it suffices to make the waveform signal S2, which is inputted to the second signal generating circuit 54, low level. Note that, in this case, because the output of the first signal generating circuit 52 does not affect the output of the second signal generating circuit 54, the level of the waveform signal S1 inputted to the first signal generating circuit 52 is not limited.

When it is desired to make the voltage level of the driving waveform the voltage level HV1, the voltage level of the output waveform from the first signal generating circuit 52 must be made to be the voltage level HV1, and the voltage level of the output waveform from the second signal generating circuit 54 also must be made to be the voltage level HV1. Accordingly, in this case, the waveform signal S1 inputted to the first signal generating circuit 52 must be made to be low level, and the waveform signal S2 inputted to the second signal generating circuit 54 must be made to be high level.

Further, when it is desired to make the voltage level of the driving waveform ground level, the voltage level of the output waveform from the first signal generating circuit 52 must be made to be ground level, and the voltage level of the output waveform from the second signal generating circuit 54 also must be made to be ground level. Accordingly, in this case, the waveform signal S1 inputted to the first signal generating circuit 52 must be made to be high level, and the waveform signal S2 inputted to the second signal generating circuit 54 also must be made to be high level.

Table 1 is a truth value table showing operation of the driving waveform generating circuit 50 relating to the present embodiment. Note that, in Table 1, S1 indicates the waveform signal inputted to the first signal generating circuit 52, S2 indicates the waveform signal inputted to the second signal generating circuit 54, and OUT indicates the voltage level of the driving waveform which is supplied to the corresponding piezoelectric element 30 from the second signal generating circuit 54.

TABLE 1

| S1 | S2 | OUT |
|---|---|---|
| None | L | HV2 |
| L | H | HV1 |
| H | H | GND |

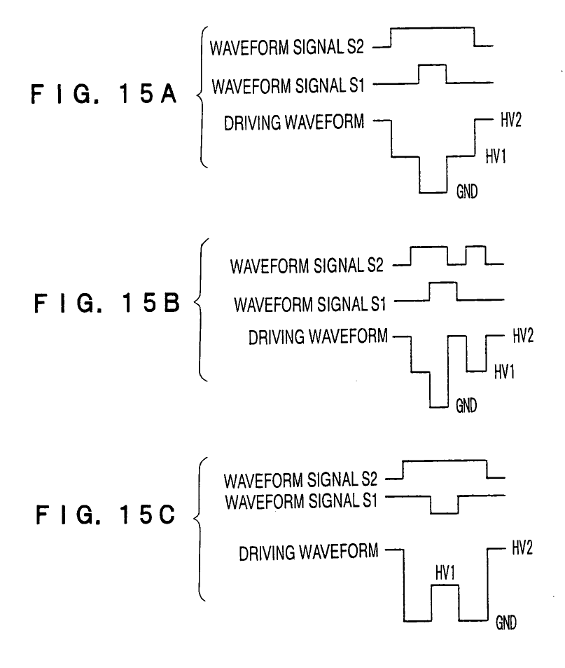

When generating the waveform signals S1, S2 to be inputted to the first signal generating circuit 52 and the second signal generating circuit 54 respectively, it suffices to, on the basis of the truth value table of Table 1, generate the pairs of the waveform signal A, the waveform signal B and the waveform signal C such that the driving waveform which is ultimately desired is obtained, and to supply the waveform signals to all of the driving ICs 16. Note that FIG. 15 shows examples of the waveform signal S1 inputted to the first signal generating circuit 52 and the waveform signal S2 inputted to the second signal generating circuit 54, as well as the driving waveform generated by these waveform signals.

In the inkjet recording device 10 relating to the present embodiment, the three types of “large drop”, “medium drop”, and “small drop” are used as the types of the ejecting amounts of the ink drops which are ejected by driving the piezoelectric element 30. The controller 12 generates the waveform signal A, the waveform signal B, and the waveform signal C respectively as three groups of waveform signals which can generate driving waveforms corresponding to these three types of ejecting amounts respectively, and these signals are inputted to the respective driving ICs 16.

In the inkjet recording device 10 relating to the present embodiment, the relationship between the voltage level HVDD of the electric power supplied from the third power source (not shown) and the voltage level HV2 of the electric power supplied from the second power source is (voltage level HVDD>voltage level HV2). The relationship between the voltage level HV2 and the voltage level HV1 of the electric power supplied from the first power source (not shown) is (voltage level HV2>voltage level HV1).

The shift register 42 provided at the driving IC 16 relating to the present embodiment is structured so as to be able to hold, at one time, the same number of print data as the number of the ejectors 32 which are the objects of driving. In contrast, as described above, a number of print data, which is equal to the number of ejectors 32 which are the objects of driving plus the numbers of ejectors 32 overlapping in the short side direction of the inkjet recording head 14 at the adjacent ejector groups 34, are inputted continuously to the shift register 42. Accordingly, print data, which is of an amount within a range of greater than or equal to the amount of print data which can be held by the shift register and less than or equal to two times that amount of print data which can be held by the shift register 42, are inputted to the driving IC 16, in accordance with the angle of each inclined side of the trapezoid which is the shape of the region where the ejector group 34 is disposed.

In the inkjet recording device 10 relating to the present embodiment, the print data inputted to each driving IC 16 from the controller 12 is inputted in a state in which the print data, which drives the ejector group 34 which is disposed at the corresponding unit structure, contains only the print data for the ejectors 32 which are included in mutually-overlapping regions of the ejector groups 34 disposed at the unit structures adjacent to that unit structure. Therefore, at the driving circuit 16, only the print data which drives the ejector group 34 which that driving IC 16 drives, must be selectively used from the inputted print data.

In order to easily realize this, a clock pre-processing section 12C (an example of a masking section) is provided at the controller 12 relating to the present embodiment.

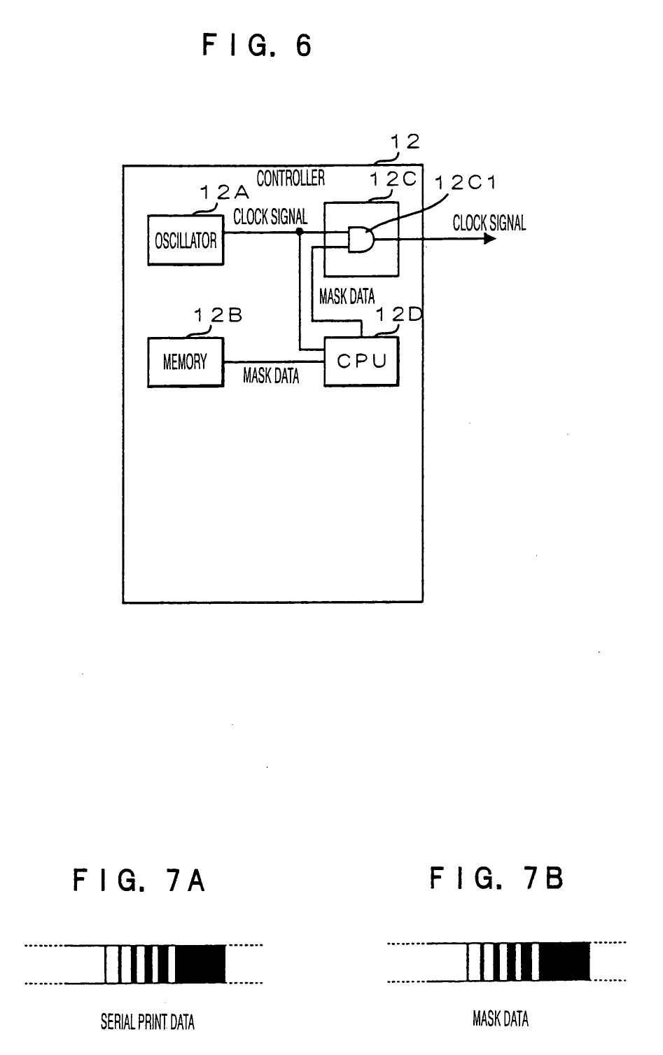

Namely, as shown in FIG. 6, the controller 12 has an oscillator 12A which generates a clock signal supplied to the driving ICs (an example of the driving circuit) 16, a non-volatile memory 12B (e.g., a flash memory), the clock pre-processing section 12C, and a CPU (Central Processing Unit) 12D which governs the operations of the entire controller 12.

The memory 12B is connected to the CPU 12D, and the CPU 12D can access the memory 12B. A 2-input, 1-output AND gate 12C1 is provided at the clock pre-processing section 12C. The output end of the oscillator 12A, which output end outputs the clock signal, is connected to one input end of the AND gate 12C1, whereas the CPU 12D is connected to the other input end of the AND gate 12C1. The output end of the oscillator 12A which outputs the clock signal is also connected to the CPU 12D. The output end of the AND gate 12C1 supplies the clock signal to the driving ICs 16.

Mask data is stored in advance in the memory 12B. Of the clock signals inputted to the driving IC 16, the mask data makes valid only the signals corresponding to the input timings, to the shift register 42, of the print data by which that driving IC 16 drives the ejector group 34 which is the object of driving, and makes invalid signals corresponding to the input timings, to the shift register 42, of the other print data (i.e., the print data for the ejectors 32 which are included in the mutually-overlapping regions of the ejector groups 34 disposed at the adjacent unit structures). Note that, in the mask data relating to the present embodiment, ‘1’ is used as data corresponding to the aforementioned timings at which the signals are made valid, and ‘0’ is used as the data corresponding to the aforementioned timings at which the signals are made invalid.

The CPU 12D reads-out the mask data from the memory 12B, and as schematically shown as an example in FIG. 7, synchronizes the mask data with the clock signals inputted from the oscillator 12A, and serially outputs the read-out mask data to the AND gate 12C1 in a state in which the mask data is synchronized with the input timings of the print data to the shift register 42 of the driving IC 16. In this way, of the clock signals inputted to the driving IC 16 from the AND gate 12C1, only the signals corresponding to the input timings, to the shift register 42, of the print data which drives the ejector group 34 which is the object of driving of that driving IC 16 are made valid, and the signals corresponding to the input timings, to the shift register 42, of the other print data are made invalid. Accordingly, at each driving IC 16, a driving waveform which drives only the ejector group 34 which is the object of driving of that IC 16, is generated, and only that ejector group 34 is driven.

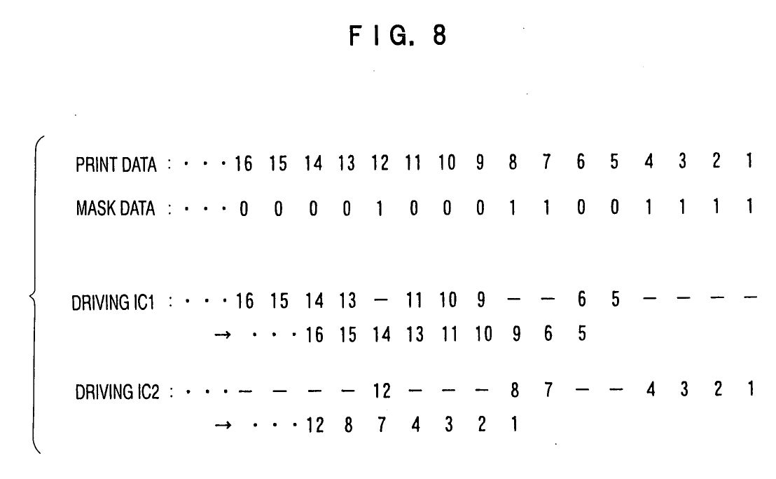

FIG. 8 schematically shows the states of the print data and the mask data, and the states of data transfer of the print data at the shift registers 42 of the two driving ICs 16 corresponding to adjacent unit structures (ejector groups 34). Note that FIG. 8 illustrates a case in which the same print data 1, 2, . . . (in actuality, each is the aforementioned 3-bit serial data) is serially inputted to these two driving ICs 16, and the illustrated mask data is applied to one of the driving ICs 16, and the inverse data of that mask data is applied to the other of the driving ICs 16. Further, in FIG. 8, the “-” symbol indicates that data transfer does not occur in the shift register 42.

As shown in FIG. 8, in this case, in the shift register 42 at the one driving IC 16, data transfer is carried out in a state in which the print data, which correspond to the timings which have been made to be ‘0’ in the mask data, are thinned out. In the shift register 42 at the other driving IC 16, data transfer is carried out in a state in which the print data, which correspond to the timings which have been made to be ‘1’ in the mask data, are thinned out.

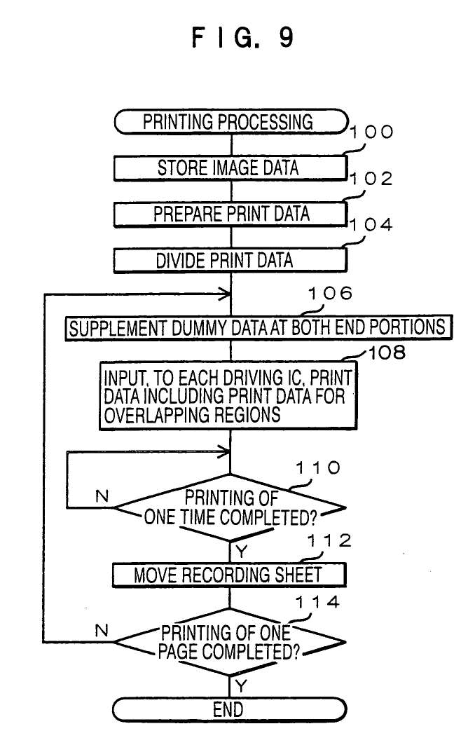

Next, operation of the inkjet recording device 10 relating to the present embodiment at the time of printing will be described with reference to FIG. 9. FIG. 9 is a flowchart showing the flow of processings of a printing processing program which is executed at the CPU 12D of the controller 12 at the time when image data, which expresses the image to be printed, is inputted from an external device such as a personal computer or the like. Note that, here, in order to avoid complication, explanation will be given of a case in which an image of one page is printed.

In step 100 of FIG. 9, inputted image data is stored once in a predetermined region of the memory 12B. In next step 102, on the basis of this image data, print data, which expresses the two-dimensional image expressed by this image data, is prepared (expanded) in a rectangular region in a two-dimensional memory space of the memory 12B.

In subsequent step 104, the print data, which is expanded in the two-dimensional memory space of the memory 12B, is divided per print data corresponding to an elongated rectangular image which is to be printed at one time by the inkjet recording head 14. This divisional print data is divided into respective print data which are to be used at the respective ejector groups 34 provided at the inkjet recording head 14.

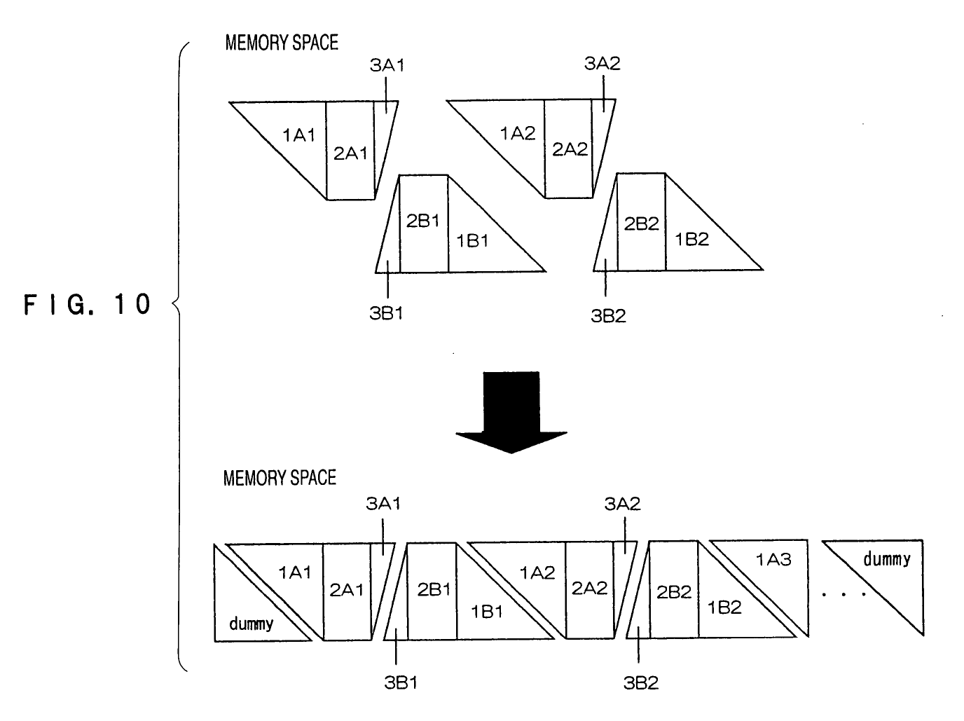

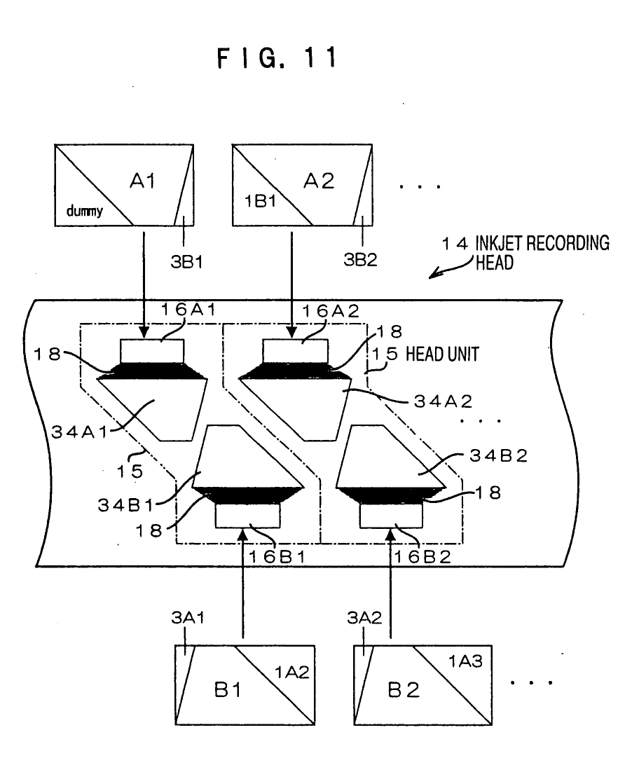

As shown in the upper portion of FIG. 10, in the two-dimensional memory space of the memory 12B, the respective print data which are obtained by this division exhibit a trapezoidal shape which is similar to the shape of the region where the corresponding ejector group 34 is disposed. Thus, as shown in FIG. 10, it is assumed that each of the trapezoids is in a state of being divided into three regions wherein the both end portions are triangular regions and the intermediate portion is a rectangular region.

In the example shown in FIG. 10, a state of being divided into two triangular regions which are region 1A1 and region 3A1 and one rectangular region which is region 2A1 as the three regions on the two-dimensional memory space of the print data corresponding to the ejector group 34A1 shown in FIG. 2, is assumed. Similarly, a state of being divided into two triangular regions which are region 3B1 and region 1B1 and one rectangular region which is region 2B1 as these three regions corresponding to the ejector group 34B1, is assumed. A state of being divided into two triangular regions which are region 1A2 and region 3A2 and one rectangular region which is region 2A2 as these three regions corresponding to the ejector group 34A2, is assumed. A state of being divided into two triangular regions which are region 3B2 and region 1B2 and one rectangular region which is region 2B2 as these three regions corresponding to the ejector group 34B2, is assumed.

In next step 106, with respect to the print data corresponding to the elongated rectangular image to be printed first by the inkjet recording head 14 (hereinafter called “object-of-processing print data”), as shown in the lower portion of FIG. 10, among the three regions on the two-dimensional memory space of the print data corresponding to the ejector groups 34 positioned at the longitudinal direction both end portions of the inkjet recording head 14 (the ejector group 34 positioned at one end portion is the ejector group 34A1), dummy data (marked as “dummy” in FIG. 10) is supplemented at the regions positioned at these longitudinal direction end portions. Note that, in the inkjet recording device 10 relating to the present embodiment, data which does not cause ink drops to be ejected from the ejectors 32 is used as the dummy data. However, the dummy data is not limited to this, and arbitrary data may be used as the dummy data.

In subsequent step 108, as shown in FIG. 11, the print data of each ejector group 34 is set in a state in which it includes only the print data for the ejectors 32 included in the mutually-overlapping regions of the adjacent ejector groups 34, and these data are serially inputted to the corresponding driving IC 16.

In this way, at each of the ejector groups 34, the print data, which corresponds to the ejectors 32 which overlap one another at ejector groups 34 which are adjacent to one another, is used in common. Note that, in FIG. 11, the region on the two-dimensional memory space of the print data corresponding to the ejector group 34A1 (the region at which the regions 1A1, 2A1 and 3A1 are combined) is denoted as ‘A1’, the region on the two-dimensional memory space of the print data corresponding to the ejector group 34B1 (the region at which the regions 3B1, 2B1 and 1B1 are combined) is denoted as ‘B1’, the region on the two-dimensional memory space of the print data corresponding to the ejector group 34A2 (the region at which the regions 1A2, 2A2 and 3A2 are combined) is denoted as ‘A2’, and the region on the two-dimensional memory space of the print data corresponding to the ejector group 34B2 (the region at which the regions 3B2, 2B2 and 1B2 are combined) is denoted as ‘B2’.

In this case, for example, print data DA1 inputted to the driving IC 16A1, print data DB1 inputted to the driving IC 16B1, print data DA2 inputted to the driving IC 16A2, and print data DB2 inputted to the driving IC 16B2 are expressed schematically as in following formulas (1) through (4).
DA1=dummy+A1+3B1 (1)
DB1=3A1+B1+1A2 (2)
DA2=1B1+A2+3B2 (3)
DB2=3A2+B2+1A3 (4)

Here, for example, the print data DA1 and the print data DB1 are expanded as shown in following formulas (5) and (6).
DA1=dummy+1A1+2A1+(3A1+3B1) (5)
DB1=(3A1+3B1)+2B1+(1B1+1A2) (6)

As shown by formulas (5) and (6), the print data formed from region 3A1 and region 3B1 are shared at the ejector group 34A1 and the ejector group 34B1.

As described above, the controller 12 inputs the print data to the shift registers 42 of the respective driving ICs 16. Further, as described above, the controller 12 inputs, to the shift registers 42 of the respective driving ICs 16, clock signals in which signals corresponding to the input timings of unneeded print data are masked via the clock pre-processing section 12C. Therefore, at each driving IC 16, expulsion of ink drops by only the corresponding ejector group 34 is carried out, and, as a result, the elongated rectangular image, which is printed at one time by the inkjet recording head 14, is printed onto the recording sheet.

In next step 110, the end of this printing of one time is waited for. In the following step 112, the recording sheet is conveyed, in the direction orthogonal to the longitudinal direction of the inkjet recording head 14, a distance corresponding to the width, in that direction, of the image which is printed at one time.

In next step 114, it is determined whether printing of an image of one page has been completed. If the determination is negative, the routine returns to above-described step 106. The present printing processing program ends at the point in time when the determination is affirmative. Note that, when repeating the processings of above-described steps 106 through 114, the print data corresponding to the image region which is to be printed next is used as the object-of-processing print data.

As described above in detail, in accordance with the present embodiment, an ejector group, in which plural ejectors which respectively eject ink drops are arranged two-dimensionally, is used as a unit structure. Plural driving circuits (here, the driving ICs 16) are provided in correspondence with the respective unit structures. On the basis of inputted print data, the driving circuit drives the ejector group disposed at the corresponding unit structure, when driving the inkjet recording head in which these plural unit structures are disposed, with respect to a predetermined one direction, such that partial regions of end portions of ejector groups disposed at adjacent unit structures overlap one another in the direction orthogonal to that one direction. The print data for driving the ejector group disposed at the corresponding unit structure is inputted to the driving circuit in a state in which the print data, which drives the ejector group disposed at the corresponding unit structure, contains only print data which drives the ejectors which are included in the mutually-overlapping regions of the ejector groups disposed at the unit structures which are adjacent to that unit structure. Therefore, it is possible to prevent a decrease in the printing speed of the inkjet recording head due to junctures of the ejector groups.

In accordance with the present embodiment, there is further provided a masking section (here, the clock pre-processing section 12C) which, with respect to the print data which is inputted to each of the plural driving circuits, masks the print data for the ejectors which are included in the mutually-overlapping regions of the ejector groups disposed at the unit structures adjacent to the corresponding unit structure. Therefore, at plural driving circuits, it is possible to reliably drive only the corresponding ejectors.

In particular, in the present embodiment, the masking section carries out masking by thinning-out, from the clock signals expressing the timings for inputting the print data to the driving circuit, the signals which correspond to the print data for the ejectors which are included in the mutually-overlapping regions of the ejector groups disposed at the adjacent unit structures. Therefore, this masking can be carried out easily.

Note that, in the present embodiment, explanation is given of a case in which one driving IC 16 is provided for each one unit structure (ejector group 34). However, the present invention is not limited to the same, and plural the driving ICs 16 may be provided for one unit structure.

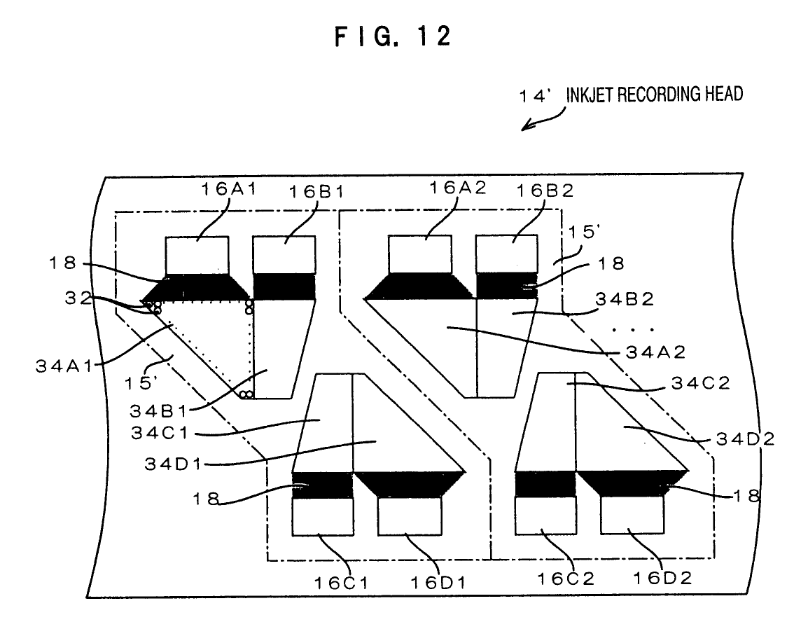

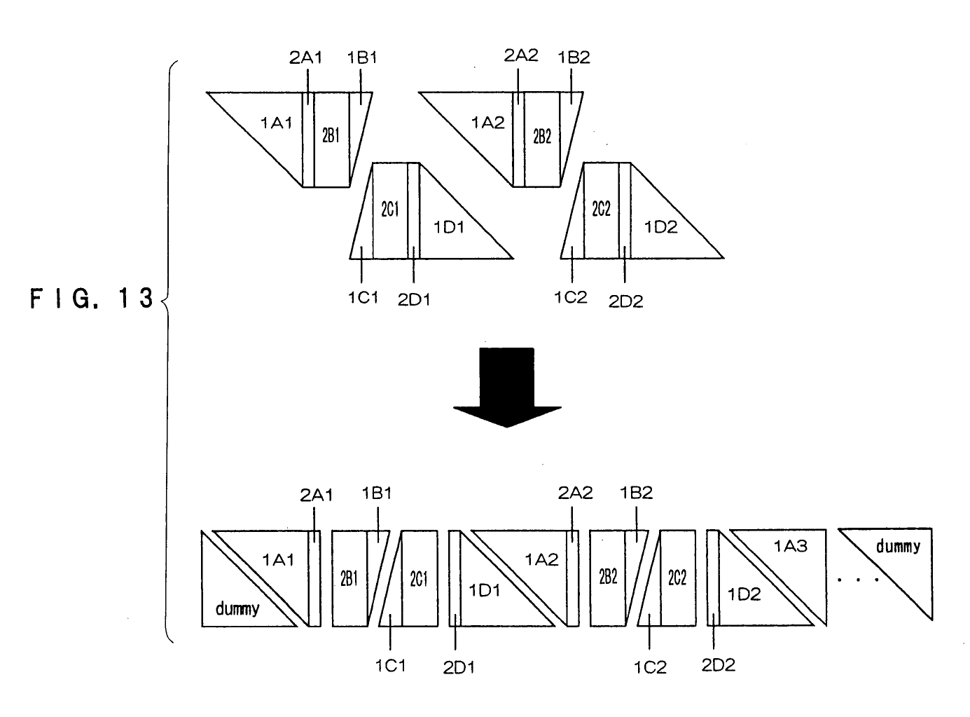

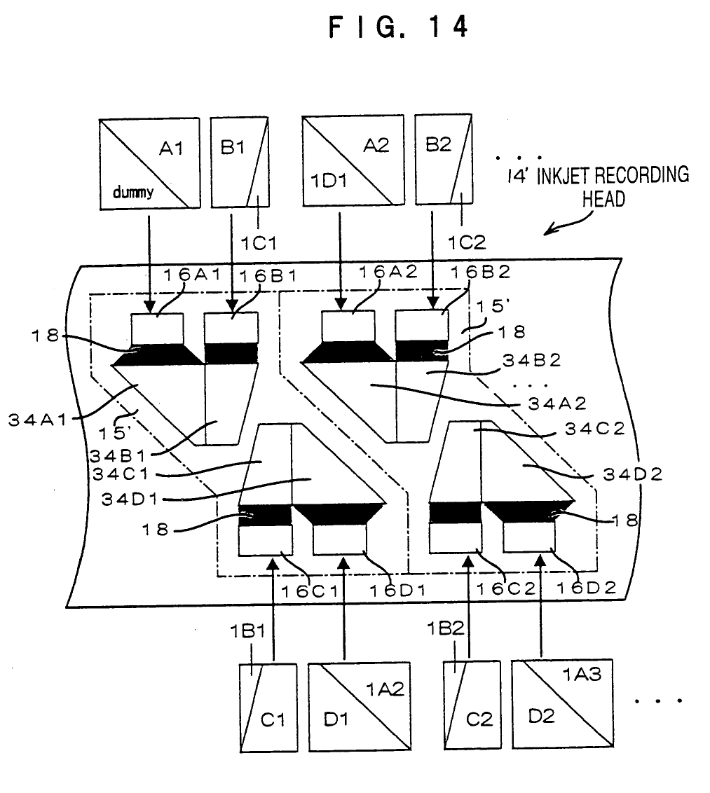

FIG. 12 shows a structural example of an inkjet recording head 14′ in a case in which two of the driving ICs 16 are provided for one unit structure.

As shown in FIG. 12, in this inkjet recording head 14′, each of the ejector groups 34, which are the unit structures in the inkjet recording head 14 relating to the above-described embodiment, is divided, by a dividing line in a direction orthogonal to the longitudinal direction of the inkjet recording head 14′, into two trapezoidal regions at which one side, of each trapezoidal region, connecting the top side and the floor side thereof is vertical. The driving ICs 16 are provided in a one-to-one correspondence with these respective divisional regions.

Here, the divisions obtained by dividing in two the ejector group 34A1 in the inkjet recording head 14 relating to the above-described embodiment are indicated as ejector group 34A1 and ejector group 34B1, the divisions obtained by dividing the ejector group 34B1 in two are indicated as ejector group 34C1 and ejector group 34D1, the divisions obtained by dividing the ejector group 34A2 in two are indicated as ejector group 34A2 and ejector group 34B2, and the divisions obtained by dividing the ejector group 34B2 in two are indicated as ejector group 34C2 and ejector group 34D2. Further, the driving IC corresponding to the ejector group 34A1 is driving IC 16A1, and the driving IC corresponding to the ejector group 34B1 is driving IC 16B1. The driving IC corresponding to the ejector group 34C1 is driving IC 16C1, and the driving IC corresponding to the ejector group 34D1 is driving IC 16D1. The driving IC corresponding to the ejector group 34A2 is driving IC 16A2, and the driving IC corresponding to the ejector group 34B2 is driving IC 16B2. The driving IC corresponding to the ejector group 34C2 is driving IC 16C2, and the driving IC corresponding to the ejector group 34D2 is driving IC 16D2.

In this case, at the time of executing the above-described printing processing program (refer to FIG. 9 as well), first, in step 100, the controller 12 stores the inputted image data once in a predetermined region of the memory 12B. In next step 102, on the basis of this image data, the controller 12 prepares (expands) print data, which expresses the two-dimensional image expressed by this image data, in a rectangular region in a two-dimensional memory space of the memory 12B.

In subsequent step 104, the print data, which is expanded in the two-dimensional memory space of the memory 12B, is divided per print data corresponding to an elongated rectangular image which is to be printed at one time by the inkjet recording head 14′. This divisional print data is divided into respective print data which are to be used at the respective ejector groups 34 (the ejector groups before being divided into two) provided at the inkjet recording head 14′.

As shown in the upper portion of FIG. 13, in the two-dimensional memory space of the memory 12B, the respective print data which are obtained by this division exhibit a trapezoidal shape which is similar to the shape of the region where the corresponding ejector group 34 is disposed. Thus, as shown in FIG. 13, it is assumed that each of the trapezoids is in a state of being divided into four regions such that the both end portions are triangular regions and the intermediate portion is two rectangular regions divided by the aforementioned dividing line.

In the example shown in FIG. 13, a state of being divided into two triangular regions which are region 1A1 and region 1B1 and two rectangular regions which are region 2A1 and region 2B1, as the four regions on the two-dimensional memory space of the print data corresponding to the ejector groups 34A1, 34B1 shown in FIG. 12, is assumed. Similarly, a state of being divided into two triangular regions which are region 1C1 and region 1D1 and two rectangular regions which are region 2C1 and region 2D1, as these four regions corresponding to the ejector groups 34C1, 34D1, is assumed. A state of being divided into two triangular regions which are region 1A2 and region 1B2 and two rectangular regions which are region 2A2 and region 2B2, as these four regions corresponding to the ejector groups 34A2, 34B2, is assumed. A state of being divided into two triangular regions which are region 1C2 and region 1D2 and two rectangular regions which are region 2C2 and region 2D2, as these four regions corresponding to the ejector groups 34C2, 34D2, is assumed.

In next step 106, with respect to the print data (object-of-processing print data) corresponding to the elongated rectangular image to be printed first by the inkjet recording head 14′, as shown in the lower portion of FIG. 13, among the four regions on the two-dimensional memory space of the print data corresponding to the ejector groups 34 positioned at the longitudinal direction both end portions of the inkjet recording head 14′ (the ejector group 34 positioned at one end portion is the ejector group 34A1), dummy data (marked as “dummy” in FIG. 13) is supplemented at the regions positioned at these longitudinal direction end portions.

In subsequent step 108, as shown in FIG. 14, the print data of each ejector group 34 (the ejector group before being divided in two; the same holds hereinafter) is set in a state in which it includes only the print data for the ejectors 32 included in the mutually-overlapping regions of the adjacent ejector groups 34, and these print data are divided in two so as to correspond to the respective driving ICs 16, and are serially inputted to the corresponding driving ICs 16.

In this way, at each of the ejector groups 34, the print data, which corresponds to the ejectors 32 which overlap one another at ejector groups 34 which are adjacent to one another, is used in common. Note that, in FIG. 14, the region on the two-dimensional memory space of the print data corresponding to the ejector group 34A1 (the region at which the regions 1A1 and 2A1 are combined) is denoted as ‘A1’, the region on the two-dimensional memory space of the print data corresponding to the ejector group 34B1 (the region at which the regions 2B1 and 1B1 are combined) is denoted as ‘B1’, the region on the two-dimensional memory space of the print data corresponding to the ejector group 34C1 (the region at which the regions 1C1 and 2C1 are combined) is denoted as ‘C1’, the region on the two-dimensional memory space of the print data corresponding to the ejector group 34D1 (the region at which the regions 2D1 and 1D1 are combined) is denoted as ‘D1’, the region on the two-dimensional memory space of the print data corresponding to the ejector group 34A2 (the region at which the regions 1A2 and 2A2 are combined) is denoted as ‘A2’, the region on the two-dimensional memory space of the print data corresponding to the ejector group 34B2 (the region at which the regions 2B2 and 1B2 are combined) is denoted as ‘B2’, the region on the two-dimensional memory space of the print data corresponding to the ejector group 34C2 (the region at which the regions 1C2 and 2C2 are combined) is denoted as ‘C2’, and the region on the two-dimensional memory space of the print data corresponding to the ejector group 34D2 (the region at which the regions 2D2 and 1D2 are combined) is denoted as ‘D2’.

As described above, the controller 12 inputs the print data to the shift registers 42 of the respective driving ICs 16. Further, as described above, the controller 12 inputs, to the shift registers 42 of the respective driving ICs 16, clock signals in which signals corresponding to the input timings of unneeded print data are masked via the clock pre-processing section 12C. Therefore, at each driving IC 16, expulsion of ink drops by only the corresponding ejector group 34 is carried out, and, as a result, the elongated rectangular image, which is printed at one time by the inkjet recording head 14′, is printed onto the recording sheet.

In next step 110, the end of this printing of one time is waited for. In the following step 112, the recording sheet is conveyed, in the direction orthogonal to the longitudinal direction of the inkjet recording head 14′, a distance corresponding to the width, in that direction, of the image which is printed at one time.

In next step 114, it is determined whether printing of an image of one page has been completed. If the determination is negative, the routine returns to above-described step 106. The present printing processing program ends at the point in time when the determination is affirmative. Note that, when repeating the processings of above-described steps 106 through 114, the print data corresponding to the image region which is to be printed next is used as the object-of-processing print data. In this case, similar effects as those of the present embodiment can be exhibited.

In the present embodiment, description is given of a case in which the clock pre-processing section 12C is provided at the controller 12. However, the present invention is not limited to the same, and, for example, a clock pre-processing section may be provided at each driving IC 16. As an embodiment of such a case, the example can be given of a form in which a memory which stores mask data is provided at each driving IC 16, the clock signal generated by the oscillator 12A is inputted from the controller 12 to the respective driving ICs 16, and in the same way as in the present embodiment, these clock signals are inputted to the shift registers 42 in states of being masked by the clock pre-processing sections 12C. In this case, similar effects as those of the present embodiment can be exhibited.

In the present embodiment, explanation is given of a case in which the shape of the region at which the ejector group of the present invention is disposed is trapezoidal. However, the present invention is not limited to the same, and may be a form utilizing a triangular shape, or a form utilizing both a trapezoidal shape and a triangular shape. In this case, similar effects as those of the present embodiment can be exhibited. Note that, when a triangular shape is used as the shape of the region where the ejector group is disposed, print data of twice the amount of print data which can be held by the shift register 42 is inputted to the driving IC 16.

The present embodiment describes a case in which the driving circuit of the present invention is structured as an IC. However, the present invention is not limited to the same, and may be a form in which the driving circuit is structured as an electronic circuit using electronic elements. Similar effects as those of the present embodiment can be exhibited in this case as well.

Further, in the present embodiment, a case is described in which the driving ICs 16 are provided at the inkjet recording head 14, but the present invention is not limited to the same. For example, a form can be used in which the respective driving ICs 16 are structured integrally with the controller 12, or a form can be used in which the controller 12 and the inkjet recording head 14 are provided as separate bodies. In this case, the size of the inkjet recording head can be made to be more compact.

Moreover, the structures of the respective portions of the inkjet recording device 10 described in the present embodiment, and the forms of the driving waveforms, the waveform signals and the various types of data (see FIGS. 1 through 8) are examples, and it goes without saying that appropriate modifications are possible within a scope which does not deviate from the gist of the present invention.

The flow of the processings of the printing processing program described in the present embodiment (see FIG. 9) is an example, and appropriate modifications can be made within a scope which does not deviate from the gist of the present invention.

### Second Embodiment

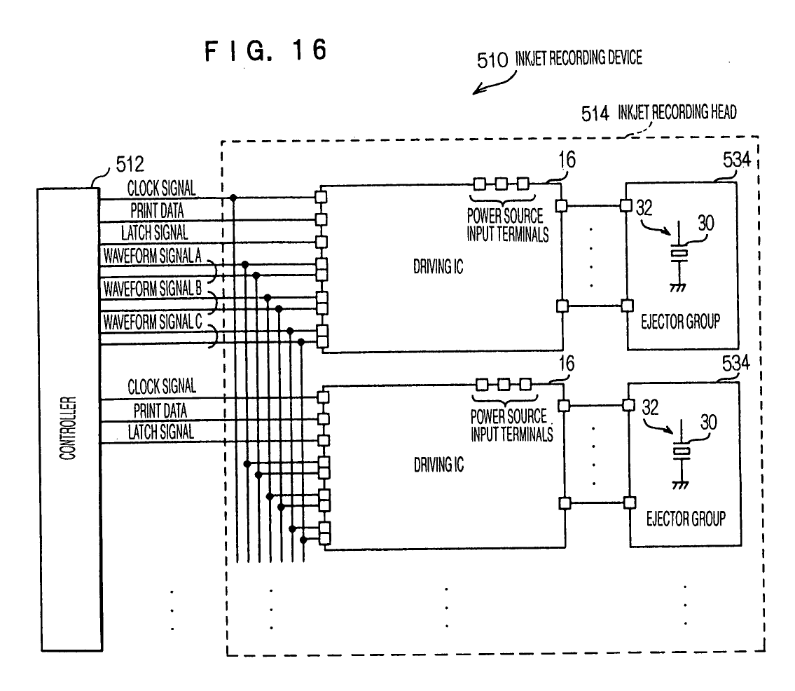

First, the structure of an inkjet recording device 510 relating to the present embodiment will be described with reference to FIGS. 16 through 18.

FIG. 16 is a drawing showing main structures of the inkjet recording device 510 relating to the present embodiment. Mainly the structures at the periphery of the inkjet recording head, except for a recording sheet conveying system, are illustrated in FIG. 16.

As shown in FIG. 16, the inkjet recording device 510 relating to the present embodiment has a controller 512 which governs the operations of the entire inkjet recording device 510, and an inkjet recording head 514 which ejects ink drops on the basis of supplied print data. The inkjet recording head 514 has plural ejector groups 534 and the driving ICs (Integrated Circuits) 16. The ejector groups 534 are structured such that plural the ejectors 32 are arranged two-dimensionally. The ejectors 32 eject ink drops due to the deformation of the piezoelectric elements (piezo elements) 30 provided individually thereat. The driving ICs 16 are provided so as to correspond to the ejector groups 534 respectively.

The inkjet recording head 514 relating to the present embodiment is an elongated structure whose width is substantially equal to the width of a recording sheet. Namely, the present inkjet recording device 510 is structured as a so-called FWA (Full-Width Array) type inkjet recording device which carries out recording while conveying only the recording sheet with the inkjet recording head 514 remaining fixed.

Similarly to the ejector 32 of the above-described first embodiment, the ejector 32 relating to the present embodiment is structured so as to include: a pressure generating chamber in which ink is filled; an ink ejecting opening which communicates with the pressure generating chamber and which can eject ink; and an actuator which has a vibrating plate structuring a portion of a wall surface of the pressure generating chamber and expanding or contracting the pressure generating chamber by vibrating, and has the piezoelectric element 30 which vibrates the vibrating plate by deforming by voltage applied thereto in accordance with image data expressing the image to be recorded.

All of the driving ICs 16 provided at the inkjet recording head 514 are connected to the controller 512. The control of the operations of the driving ICs 16 is carried out by the controller 512 by using clock signals, print data, and latch signals, as well as the waveform signal A, the waveform signal B and the waveform signal C, each of which is a pair of signals, and the like.

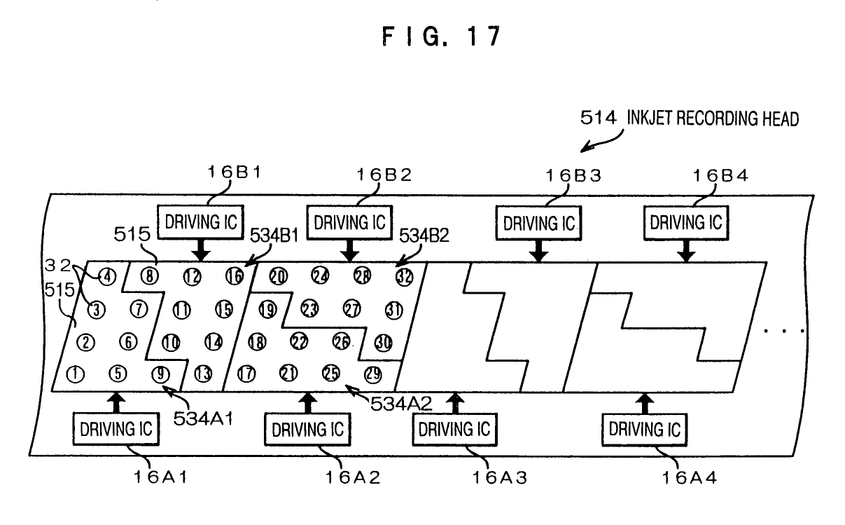

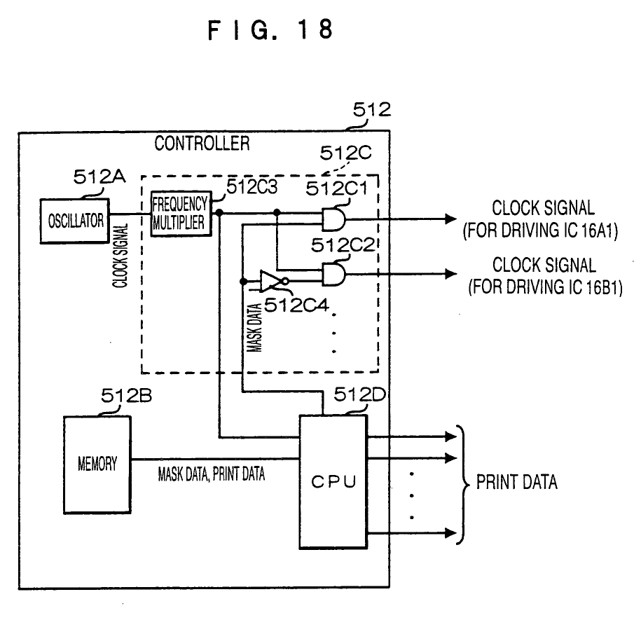

A plan view showing the schematic structure of the inkjet recording head 514 relating to the present embodiment is shown in FIG. 17.

As shown in FIG. 17, at the inkjet recording head 514 relating to the present embodiment, each of ejector groups 534A1, 534B1, 534A2, 534B2, . . . , which is structured by plural the ejectors 32 being arranged two-dimensionally, is a unit structure. The plural unit structures are disposed, with respect to a predetermined one direction (the longitudinal direction (elongated direction) of the inkjet recording head 514), such that a partial region at one end portion of the ejector group thereof and a partial region of the end portion at the ejector group of an adjacent unit structure are in a state of overlapping one another in a direction orthogonal to the aforementioned one direction (i.e., in the short side direction of the inkjet recording head 514).

The driving ICs 16A1, 16B1, 16A2, 16B2 . . . are provided individually in a one-to-one correspondence with the ejector groups 534A1, 534B1, 534A2, 534B2, . . . . The ejector groups and the corresponding driving ICs are electrically connected by respective connecting wires (not shown). Hereinafter, the ejector groups 534A1, 534B1, 534A2, 534B2, . . . may be abbreviated as “the ejector group 534”, other than in cases of designating a specific ejector group. Further, hereinafter, the driving ICs 16A1, 16B1, 16A2, 16B2 . . . may be abbreviated as “the driving IC 16”, other than in cases of designating a specific driving IC.

By combining two of the ejector groups 534 relating to the present embodiment, the ejector groups 534 are structured as unit parts as head units 515 whose outer peripheral configuration is a parallel quadrilateral configuration as seen in plan view, and in which partial regions of the respective ejector groups at the end portions at the sides where the ejector groups are combined, overlap one another in the direction orthogonal to the direction in which the ejector groups are combined. In the inkjet recording head 514 relating to the present embodiment, plural pairs of the head units 515 are lined-up in the longitudinal direction.

The structures and operations of the driving IC 16 and the level shifter 48 relating to the present embodiment are the same as those relating to the above-described first embodiment (refer to FIGS. 3 through 5, FIG. 15, and Table 1), and therefore, description thereof will be omitted here. However, in the above-described first embodiment, with regard to the print data inputted to the shift register 42 at the driving IC 16, a number of these print data, which number is the sum of the number of ejectors 32 included in the corresponding ejector group 34 plus the number of ejectors 32 of adjacent ejector groups 34 which ejectors 32 are overlapping in the short side direction of the inkjet recording head 14, are continuously inputted. In contrast, the present second embodiment differs in that the print data which drive all of the ejectors 32 disposed at the corresponding head unit 515 are included, and are continuously inputted in a state in which the image to be recorded is substantially rectangular.

In this way, in the inkjet recording device 510 relating to the present embodiment, the print data inputted to the respective driving ICs 16 from the controller 512 is such that the print data, which drive all of the ejectors 32 disposed at the corresponding head unit 515, are included, and the image to be recorded is substantially rectangular. Therefore, the driving IC 16 must selectively use, from among the inputted print data, only the print data which drives the ejector group 534 which that driving IC 16 drives.

In order to realize this easily, a clock pre-processing section 512C is provided at the controller 512 relating to the present embodiment.

Namely, as shown in FIG. 18, the controller 512 has an oscillator 512A (an example of a clock signal generating section) which generates a clock signal which is a reference signal for controlling operation of the inkjet recording device 510, a non-volatile memory 512B (an example of a memory section, and, as a more specific example, a flash memory), the clock pre-processing section 512C, and a CPU (Central Processing Unit) 512D which governs the overall operations of the controller 512. Note that, in order to avoid complication, in FIG. 18, only the portions relating to the driving IC 16A1 and the driving IC 16B1 are shown as the clock pre-processing section 512C, and hereinafter, description will mainly be given of these portions. However, the same holds for the portions relating to the other driving ICs 16 as well.

The memory 512B is connected to the CPU 512D, and the CPU 512D can access the memory 512B.

The clock pre-processing section 512C has 2-input, 1-output AND gates 512C1, 512C2, a frequency multiplier 512C3, and an inverter 512C4. The output end, which outputs the clock signal, of the oscillator 512A is connected to the input end of the frequency multiplier 512C3. At the frequency multiplier 512C3, the frequency of the inputted clock signal is multiplied by two and outputted. The output end of the frequency multiplier 512C3, which output end outputs the clock signal whose frequency has been multiplied by two, is connected to the CPU 512D and to one input end of each of the AND gates 512C1, 512C2. The clock signal, whose frequency has been multiplied by two (hereinafter called the “2× frequency clock signal”) is inputted to the respective one input ends of the AND gates 512C1, 512C2 and to the CPU 512D.

The CPU 512D is directly connected to the other input end of the AND gate 512C1. The CPU 512D is connected to the other input end of the AND gate 512C2 via the inverter 512C4. The output end of the AND gate 512C1 supplies the clock signal to the driving IC 16A1, and the output end of the AND gate 512C2 supplies the clock signal to the driving IC 16B1.

Mask data is stored in advance in the memory 512B. Of the clock signals inputted to the driving ICs 16, the mask data makes valid only the pulses corresponding to the input timings, to the shift registers 42, of the print data by which the driving ICs 16 drive the ejector groups 534 which are the objects of driving, and makes invalid the pulses corresponding to the input timings, to the shift registers 42, of the other print data.

The controller 512 relating to the present embodiment divides all of the print data of the image which is the object of recording into groups of data, which data are such that the image to be recorded is substantially rectangular and are the same number as the number of ejectors (here, eight) of one ejector group 34. The controller 512 serially inputs, to each of the driving ICs 16 and as print data, only the print data of the divisional group, in which is included the print data which drives the ejectors 32 disposed at the corresponding head unit 515 (an example of the unit structure). As a result, for example, all of the print data which drive the ejector group 534A1 and the ejector group 534B1 are inputted to both the driving IC 16A1 and the driving IC 16B1.

The memory 512B of the controller 512 relating to the present embodiment stores, in advance, mask data which corresponds to the respective head units 515 and which is structured as binary data indicating that, of all of the print data included in the divisional group which contains the most print data for driving the ejectors 32 disposed at the corresponding head unit 515, the print data which drive the ejectors 32 disposed at that head unit 515 are not masked, and the print data other than those print data are masked. Note that, in the present embodiment, ‘1’ is used as the value expressing do not mask, and ‘0’ is used as the value expressing mask. In the inkjet recording head 514 shown in FIG. 17, for example, ‘1, 1, 1, 1, 1, 1, 1, 0’ is stored in the memory 512B as mask data corresponding to the driving IC 16A1, and ‘0, 1, 1, 1, 1, 1, 1, 1’ is stored in the memory 512B as mask data corresponding to the driving IC 16B1.

The controller 512 carries out masking by using composite mask data which combines: mask data corresponding to the head unit 515 which is the object of driving of the driving IC 16 which is the object of input of the print data; and inverted data of the mask data corresponding to the head unit 515 in which a partial region of the end portion of the ejector group 534 overlaps, in the short side direction of the inkjet recording head 514, a partial region of the end portion of the ejector group 534 of the aforementioned head unit 515. As a result, for example, at the inkjet recording head 514 shown in FIG. 17, ‘1, 1, 1, 1, 1, 1, 1, 0, 1, 0, 0, 0, 0, 0, 0, 0’ is prepared and used as the composite mask data which masks the print data inputted to the driving IC 16A1.

As shown in FIG. 18, the inverted data (data in which ‘1’ is made to be ‘0’, and ‘0’ is made to be ‘1’) of the above mask data is inputted to the AND gate 512C2 which outputs the clock signal supplied to the driving IC 16B1. This is because, in the case of the inkjet recording head 514 shown in FIG. 17, the print data supplied to adjacent driving ICs 16 are the same, and the print data which are actually used among that print data are those of mutually opposite regions.

The CPU 512D reads-out the needed mask data from the memory 512B, and prepares the composite mask data on the basis thereof. The CPU 512D synchronizes the composite mask data with the clock signal which is inputted from the frequency multiplier 512C3 and whose frequency has been multiplied by two, and serially outputs the prepared composite mask data to the AND gate 512C1 and the inverter 512C4 in a state in which the composite mask data is synchronized with the input timings of the print data to the shift register 42 of the driving IC 16. In this way, of the clock signals inputted to the corresponding driving ICs 16 from the AND gate 512C1 and the AND gate 512C2, only the signals corresponding to the input timings, to the shift register 42, of the print data which drives the ejector group 534 which is the object of driving of that driving IC 16 are made valid, and the signals corresponding to the input timings, to the shift register 42, of the other print data are made invalid. Accordingly, at each driving IC 16, a driving waveform which drives only the ejector group 534 which is the object of driving of that IC 16, is generated, and only that ejector group 534 is driven.

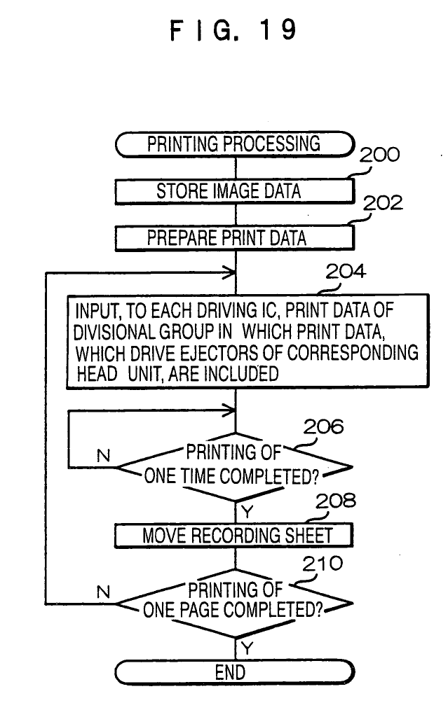

Next, operation of the inkjet recording device 510 relating to the present embodiment at the time of printing will be described with reference to FIG. 19. FIG. 19 is a flowchart showing the flow of processings of a printing processing program which is executed at the CPU 512D of the controller 512 at the time when image data, which expresses the image to be printed, is inputted from an external device such as a personal computer or the like. Note that, here, in order to avoid complication, explanation will be given of a case in which an image of one page is printed.

In step 200 of FIG. 19, inputted image data is stored once in a predetermined region of the memory 512B. In next step 202, on the basis of this image data, print data, which expresses the two-dimensional image expressed by this image data, is prepared (expanded) in a rectangular region in a two-dimensional memory space of the memory 512B.

In subsequent step 204, by using the print data (hereinafter called “object-of-processing print data”) corresponding to the elongated rectangular image region which is to be printed first by the inkjet recording head 514, only the print data of the aforementioned divisional group which include the print data which drive the ejectors 32 disposed at the corresponding head units 515, are serially inputted to the driving ICs 16 as print data, in a state of being synchronized with the 2× frequency clock signal inputted from the frequency multiplier 512C.

As described above, the controller 512 inputs the print data to the shift registers 42 of the respective driving ICs 16. Further, as described above, the controller 512 inputs, to the shift registers 42 of the respective driving ICs 16, clock signals in which pulses corresponding to the input timings of unneeded print data are masked via the clock pre-processing section 512C. Therefore, at each driving IC 16, the expulsion of ink drops by only the corresponding ejector group 34 is carried out, and, as a result, the elongated rectangular image, which is printed at one time by the inkjet recording head 514, is printed onto the recording sheet.

In next step 206, the end of this printing of one time is waited for. In following step 208, the recording sheet is conveyed, in the direction orthogonal to the longitudinal direction of the inkjet recording head 514, a distance corresponding to the width, in that direction, of the image which is printed at one time.

In next step 210, it is determined whether printing of an image of one page has been completed. If the determination is negative, the routine returns to above-described step 204. The present printing processing program ends at the point in time when the determination is affirmative. Note that, when repeating the processings of above-described steps 204 through 210, the print data corresponding to the image region which is to be printed next is used as the object-of-processing print data.

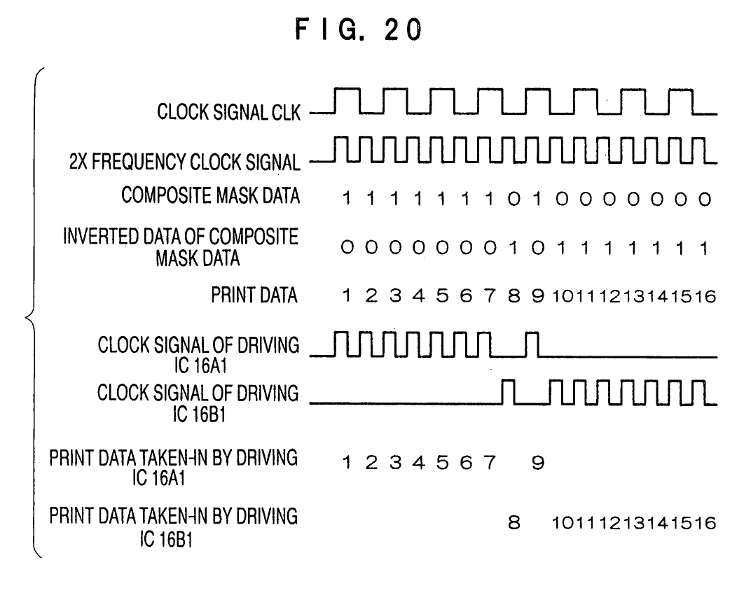

Next, with reference to FIG. 20, the portions relating to the driving IC 16A1 and the driving IC 16B1 will be described as concrete examples of the generated states of the clock signals supplied to the respective driving ICs 16 at the controller 512 and the states of the print data taken-in by the respective driving ICs 16.

As shown in FIG. 20, at the controller 512, the 2× frequency clock signal, whose frequency is twice that of the clock signal CLK generated by the oscillator 512A, is generated by the frequency multiplier 512C3, and is inputted to one input end of each of the AND gates 512C1, 512C2.

At the time when printing is carried out, the CPU 512D reads-out the mask data stored in the memory 512B, and combines the mask data corresponding to the driving IC 16A1 and the inverted data of the mask data corresponding to the driving IC 16B1 so as to prepare the composite mask data (here, ‘1, 1, 1, 1, 1, 1, 1, 0, 1, 0, 0, 0, 0, 0, 0, 0’), and serially outputs the prepared composite mask data to the AND gate 512C1 and the inverter 512C4.

In this way, as shown in FIG. 20, the clock signal outputted to the driving IC 16A1 from the AND gate 512C1 is in a state in which the eighth and the tenth through the sixteenth pulses are eliminated (a low-level state), and the clock signal outputted to the driving IC 16B1 from the AND gate 512C2 is in a state in which the first through the seventh and the ninth pulses are eliminated (a low-level state).

As a result, the print data taken-in by the shift registers 42 of the driving IC 16A1 and the driving IC 16B1 are only the print data which drive the ejectors 32 which are the objects of driving thereof.

Accordingly, at the driving ICs 16A1, 16B1, the driving waveform which drives only the ejector group 534 which is the object of driving of that driving IC 16, is generated, and only that ejector group 534 is driven.

Here, description has been given focusing on the driving ICs 16A1, 16B1, but the operation is the same for the other driving ICs as well.

As described above in detail, in accordance with the present embodiment, plural driving circuits (here, the driving ICs 16) are respectively provided in correspondence with plural unit structures (here, the head units 515) which have ejector groups in which plural ejectors which respectively eject ink drops are arranged two-dimensionally. On the basis of inputted print data, the driving circuit drives the ejector group of the corresponding unit structure, when driving the inkjet recording head in which these plural unit structures are disposed in a state in which, with respect to a predetermined one direction, a partial region at least one end portion of an ejector group mutually overlaps a partial region at the end portion of the ejector group of the adjacent unit structure, in the direction orthogonal to that one direction. Print data, which is such that the recorded image is substantially rectangular (a parallelogram in the example shown in FIG. 17) and which includes print data which drives all of the ejectors disposed at the corresponding unit structure, are serially inputted to each of plural driving circuits and as print data, in a state in which the print data which drives ejectors other than the ejectors disposed at the corresponding unit structure are masked. Therefore, it is possible to prevent a decrease in the printing speed of the inkjet recording head due to junctures of the unit structures.

In accordance with the present embodiment, all of the print data of the image which is the object of recording is divided into groups of data, which are such that the image to be recorded is substantially rectangular and which are of a number equal to the number of ejectors of one ejector group. Only the print data of the divisional group that includes the print data that drives the ejectors disposed at the corresponding unit structure, are serially inputted to the driving circuit as print data. Therefore, the amount of inputted print data can be kept to a minimum, and a decrease in the printing speed can be prevented even more.

In particular, in the present embodiment, the memory section (here, the memory 512B) stores, in advance, mask data which corresponds to the respective unit structures and which is structured as binary data indicating that, of all of the print data included in the divisional group which contains the most print data driving the ejectors disposed at the corresponding unit structure, the print data which drives the ejectors disposed at that unit structure are not masked, and the print data other than that print data are masked. The print data which are inputted to each of plural driving circuits are masked by using composite mask data which combines: mask data corresponding to the unit structure which is the object of driving of the driving circuit which is the object of input of the print data; and inverted data of the mask data corresponding to the unit structure in which a partial region of the end portion of the ejector group overlaps, in the direction orthogonal to the aforementioned one direction, a partial region of the end portion of the ejector group of the aforementioned unit structure. Therefore, the storage capacity needed for this storage can be reduced as compared with a case in which composite mask data is stored as mask data corresponding to all of the unit structures.

Further, in accordance with the present embodiment, there is also provided the clock signal generating section (here, the oscillator 512A) which generates a clock signal of a predetermined frequency. The print data is inputted to the corresponding driving circuit in a state of being synchronized with the clock signal. Masking is carried out by thinning-out, by using the aforementioned composite mask data, the pulses in the clock signal which pulses correspond to the input timings of the print data which are objects of masking. Therefore, masking can be carried out easily and in a short period of time.

In particular, in accordance with the present embodiment, the clock signal after the above-described thinning is generated by obtaining the logical product of the composite mask data and the 2× frequency clock signal which is obtained by multiplying the frequency of the clock signal by two. This print data is inputted to the corresponding driving circuit in a state of being synchronized with the post-thinning clock signal. Therefore, it is possible to realize a printing speed of the same extent as a case supposing the inputting, to a driving circuit, of print data corresponding only to the ejectors which are driven by that driving circuit.

### Third Embodiment

In the present third embodiment, explanation is given of an example of a case in which the respective ejector groups 534 are driven in a state in which the ejectors 32 included in each ejector group 534 are divided into two systems. Note that the structures of the inkjet recording device 510 relating to the present third embodiment are, with the exception of the structures of the driving ICs 16 and the controller 512, the same as those of the inkjet recording device 510 relating to the above-described second embodiment. Therefore, here, the structures of the driving ICs 16 and the controller 512 relating to the present third embodiment will be described first.

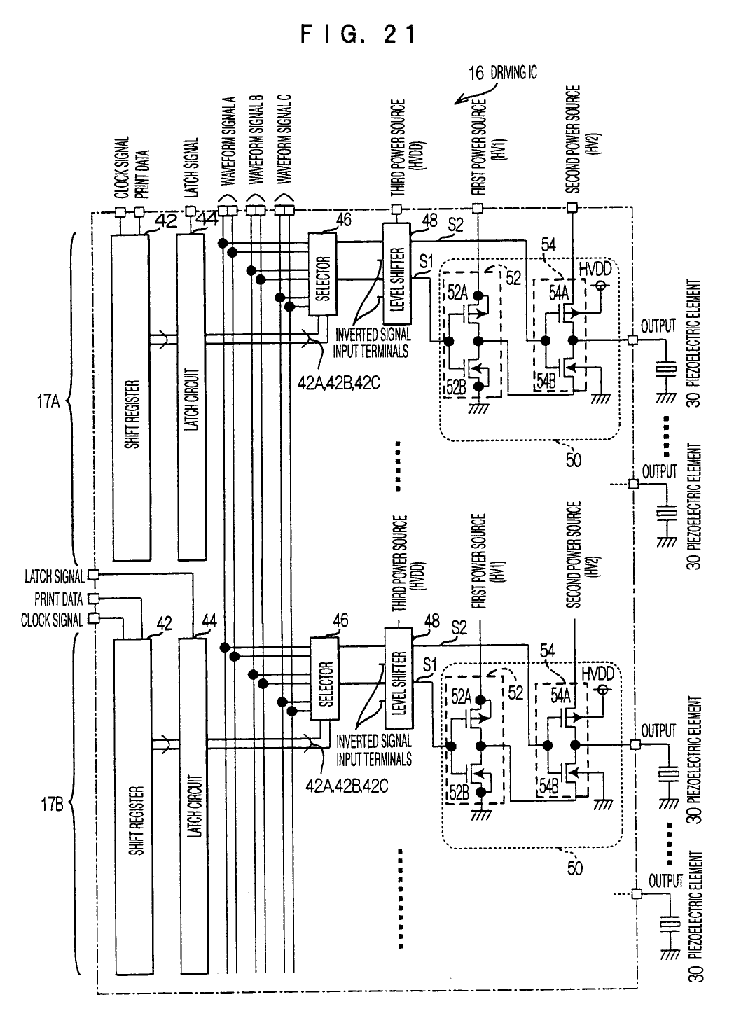

The structure of the driving IC 16 relating to the present third embodiment is shown in FIG. 21. Note that, in FIG. 21, structural elements which are similar to those of FIG. 3 are denoted by the same reference numerals as in FIG. 3, and description thereof is omitted.

As shown in FIG. 21, the driving IC 16 relating to the present embodiment differs from the driving IC 16 relating to the above-described second embodiment in that, in the present embodiment, the structure formed from the shift register 42, the latch circuit 44, the selector 46, the level shifter 48, and the driving waveform generating circuit 50 is provided for two systems which are a system corresponding to the odd-numbered nozzles (hereinafter, “odd-numbered nozzle corresponding portion 17A”) and a system corresponding to the even-numbered nozzles (hereinafter, “even-numbered nozzle corresponding portion 17B”), in the order of arrangement in the longitudinal direction of the inkjet recording head 514 from the left end thereof in FIG. 17.

Plural driving waveform generating circuits 50 provided at the odd-numbered nozzle corresponding portion 17A are connected, in a one-to-one correspondence, to the piezoelectric elements 30 corresponding to the odd-numbered nozzles. Plural driving waveform generating circuits 50 provided at the even-numbered nozzle corresponding portion 17B are connected, in a one-to-one correspondence, to the piezoelectric elements 30 corresponding to the even-numbered nozzles. Clock signals, print data, and latch signals are inputted individually to the shift registers 42 and the latch circuits 44 provided at the odd-numbered nozzle corresponding portion 17A and to the shift registers 42 and the latch circuits 44 provided at the even-numbered nozzle corresponding portion 17B.

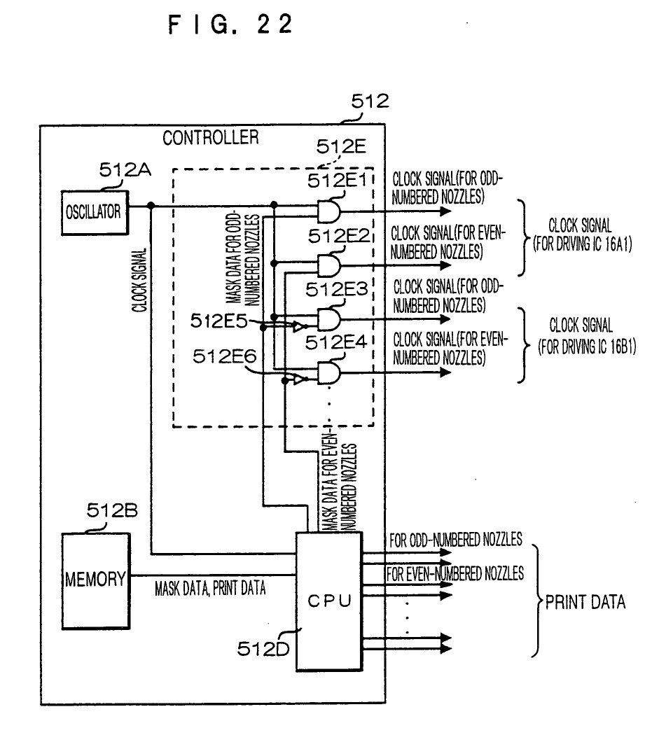

The structure of the controller 512 relating to the present third embodiment is shown in FIG. 22. Structural elements in FIG. 22 which are similar to those in FIG. 18 are denoted by the same reference numerals as in FIG. 18, and description thereof is omitted. Further, in order to avoid complication, in FIG. 22, only the portions relating to the driving IC 16A1 and the driving IC 16B1 are shown as a clock pre-processing section 512E (an example of the masking means). Hereinafter, explanation will be given mainly with respect to these portions, but the same holds for the portions relating to the other driving ICs 16 as well.

As shown in FIG. 22, as compared with the controller 512 relating to the above-described second embodiment, the controller 512 of the present embodiment differs only with respect to the point that it utilizes, instead of the clock pre-processing section 512C, the clock pre-processing section 512E which corresponds to the odd-numbered nozzle corresponding portion 17A and the even-numbered nozzle corresponding portion 17B.

Four 2-input, 1-output AND gates 512E1 through 512E4 and two inverters 512E5, 512E6 are provided at the clock pre-processing section 512E relating to the present embodiment. The output end, which outputs the clock signal, of the oscillator 512A is connected to the CPU 512D and to one input end of each of the AND gates 512E1 through 512E4. The clock signal is inputted to the CPU 512 and to the one input ends of the AND gates 512E1 through 512E4, respectively.

A first output end of the CPU 512D, which outputs masking data for odd-numbered nozzles which will be described later, is connected directly to the other input end of the AND gate 512E1. This first output end of the CPU 512D is connected, via the inverter 512E5, to the other input end of the AND gate 512E3. Further, a second output end of the CPU 512D, which outputs masking data for even-numbered nozzles which will be described later, is connected directly to the other input end of the AND gate 512E2. This second output end of the CPU 512D is connected, via the inverter 512E6, to the other input end of the AND gate 512E4.

The output end of the AND gate 512E1 supplies the clock signal to the shift register 42 of the odd-numbered nozzle corresponding portion 17A of the driving IC 16A1. The output end of the AND gate 512E2 supplies the clock signal to the shift register 42 of the even-numbered nozzle corresponding portion 17B of the driving IC 16A1. The output end of the AND gate 512E3 supplies the clock signal to the shift register 42 of the odd-numbered nozzle corresponding portion 17A of the driving IC 16B1. The output end of the AND gate 512E4 supplies the clock signal to the shift register 42 of the even-numbered nozzle corresponding portion 17B of the driving IC 16B1.

The controller 512 relating to the present embodiment prepares, for the print data inputted to each of the driving ICs 16, composite mask data which combines: mask data corresponding to the head unit 515 which is the object of driving of the driving IC 16 which is the object of input of the print data; and inverted data of the mask data corresponding to the head unit 515 at which a partial region of the end portion of the ejector group 534 overlaps, in the short side direction of the inkjet recording head 514, a partial region of the end portion of the ejector group 534 of the aforementioned head unit 515. Thereafter, the controller 512 classifies this composite mask data into mask data (hereinafter called “mask data for odd-numbered nozzles”) which masks the print data inputted to the odd-numbered nozzle corresponding portion 17A, and mask data (hereinafter called “mask data for even-numbered nozzles”) which masks the print data inputted to the even-numbered nozzle corresponding portion 17B, and carries out masking in parallel by using these masking data. Note that, at the inkjet recording head 514 shown in FIG. 17, ‘1, 1, 1, 1, 1, 0, 0, 0’ is prepared and used as the mask data for odd-numbered nozzles for the driving IC 16A1, and ‘1, 1, 1, 0, 0, 0, 0, 0’ is prepared and used as the mask data for even-numbered nozzles.

Here, the inverted data (data in which ‘1’ is made to be ‘0’, and ‘0’ is made to be ‘1’) of the mask data inputted to the AND gates 512E1, 512E2 is inputted to the AND gates 512E3, 512E4 which output the clock signals supplied to the driving IC 16B1. This is because the print data supplied to adjacent driving ICs 16 are the same, and the print data which are actually used among that print data are data of mutually opposite regions.

The CPU 512D reads-out the needed mask data from the memory 512B, and prepares the composite mask data on the basis thereof. Thereafter, by using this composite mask data, the CPU 512D prepares the mask data for odd-numbered nozzles and the mask data for even-numbered nozzles. The CPU 512D synchronizes these data with the clock signal which is inputted from the oscillator 512A, and outputs the mask data for odd-numbered nozzles to the AND gate 512E1 and the inverter 512E5, and outputs the mask data for even-numbered nozzles to the AND gate 512E2 and the inverter 512E6, in the state of being synchronized with the input timings of the print data to the shift registers 42 of the driving ICs 16. In this way, of the clock signals inputted to the corresponding driving IC 16 from the AND gate 512E1 through the AND gate 512E4, only the signals corresponding to the input timings, to the shift register 42, of the print data which drives the ejector group 534 which is the object of driving of that driving IC 16 are made valid, and the signals corresponding to the input timings, to the shift register 42, of the other print data are made invalid. Accordingly, at each driving IC 16, the driving waveform which drives only the ejector group 534 which is the object of driving of that IC 16, is generated, and only that ejector group 534 is driven.

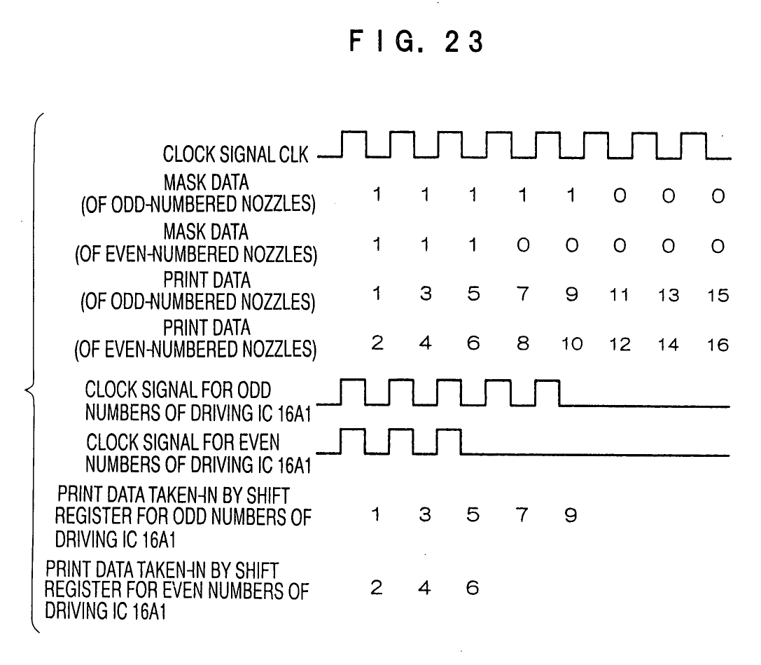

Next, with reference to FIG. 23, explanation will be given of the portion relating to the driving IC 16A1, as concrete explanation of the generated states of the clock signals supplied to the respective driving ICs 16 at the controller 512 and the states of the print data taken-in by the respective driving ICs 16.

As shown in FIG. 23, at the controller 512, the clock signal CLK generated by the oscillator 512A is inputted to one input end of each of the AND gates 512E1 through 512E4.

At the time when printing is carried out, the CPU 512D reads-out the mask data stored in the memory 512B, and combines the mask data corresponding to the driving IC 16A1 and the inverted data of the mask data corresponding to the driving IC 16B1 so as to prepare the composite mask data (here, ‘1, 1, 1, 1, 1, 1, 0, 1, 0, 0, 0, 0, 0, 0, 0’). By using the prepared composite mask data, the CPU 512D prepares the mask data for odd-numbered nozzles and the mask data for even-numbered nozzles, and serially outputs the mask data for odd-numbered nozzles to the AND gate 512E1 and the inverter 512E5, and serially outputs the mask data for even-numbered nozzles to the AND gate 512E2 and the inverter 512E6.

In this way, as shown in FIG. 23, the clock signal outputted from the AND gate 512E1 to the shift register 42 of the odd-numbered nozzle corresponding portion 17A of the driving IC 16A1 is in a state in which the sixth through eighth pulses are eliminated (a low-level state), and the clock signal outputted from the AND gate 512E2 to the shift register 42 of the even-numbered nozzle corresponding portion 17B of the driving IC 16A1 is in a state in which the fourth through eighth pulses are eliminated (a low-level state).

At this time, as shown in FIG. 23, also with regard to the print data outputted to the odd-numbered nozzle corresponding portion 17A and the even-numbered nozzle corresponding portion 17B of each of the driving ICs 16, the CPU 512D serially inputs the print data corresponding to the odd-numbered nozzles (hereinafter called “print data for odd-numbered nozzles”) to the odd-numbered nozzle corresponding portion 17A, and serially inputs print data corresponding to the even-numbered nozzles (hereinafter called “print data for even-numbered nozzles”) to the even-numbered nozzle corresponding portion 17B.

As a result, the print data, which is taken-in by the shift registers 42 of the odd-numbered nozzle corresponding portion 17A and the even-numbered nozzle corresponding portion 17B of the driving IC 16A1, is only data which drives the ejectors 32 which are the objects of driving thereof.

Accordingly, at the driving IC 16A1, a driving waveform which drives only the ejector group 534 which is the object of driving of that IC 16A1, is generated, and only that ejector group 534 is driven.

Here, description has been given focusing on the driving IC 16A1, but the operation is the same for the other driving ICs 16 as well.

As described above in detail, the present embodiment can exhibit the effects of the above-described second embodiment, other than the effects relating to the 2× frequency clock signal. Further, the composite mask data is classified into two systems which are set in advance, and the logical products of the clock signals and the composite mask data of these two groups after the classification are obtained in parallel. In this way, post-thinning clock signals are generated in parallel for the two systems, and the print data is classified into these two systems. The two groups of classified print data are inputted to the corresponding driving circuit (here, the driving IC 16) in a state of being synchronized with the corresponding clock signal among the clock signals for the two systems. Therefore, it is possible to realize a printing speed of the same extent as a case supposing the inputting, to each driving circuit, of the print data corresponding only to the ejectors which are driven by that driving circuit.

### Fourth Embodiment

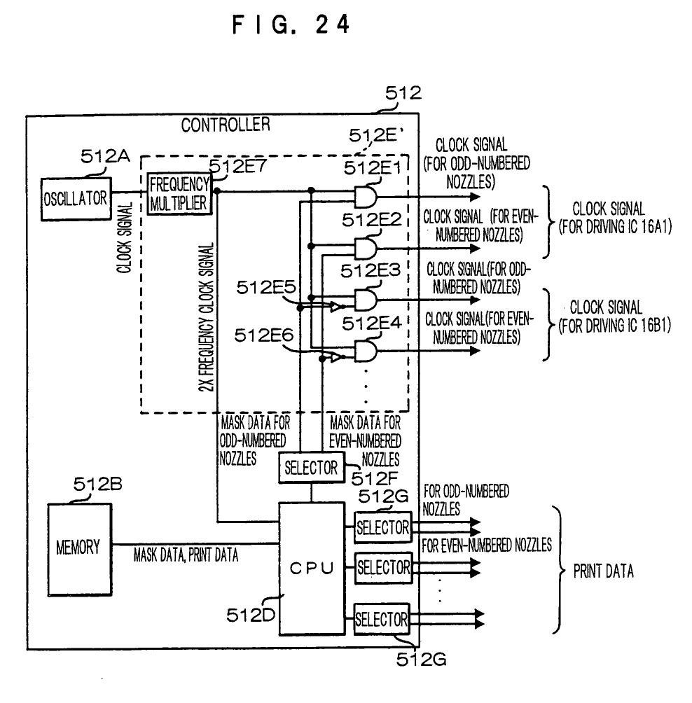

In the present fourth embodiment, a modified example of the above-described third embodiment will be described. The structure of the inkjet recording device 510 relating to the present fourth embodiment is similar to that of the inkjet recording device 510 of the above-described third embodiment, except for the structure of the controller 512. Here, first, the structure of the controller 512 relating to the present fourth embodiment will be described with reference to FIG. 24. Note that structural elements which are similar to those of FIG. 22 are denoted by the same reference numerals in FIG. 24, and description thereof will be omitted.

As shown in FIG. 24, the controller 512 relating to the present embodiment differs from the controller 512 relating to the above-described third embodiment only with respect to the points that a clock pre-processing section 512E′ having a frequency multiplier 512E7 is used instead of the clock pre-processing section 512E, and that a selector 512F for mask data classification and selectors 512G for print data classification are newly provided.

Namely, the frequency multiplier 512E7, which multiplies by two the frequency of the clock signal inputted from the oscillator 512A and inputs it to the CPU 512D and ones of input ends of the AND gates 512E1 through 512E4, is provided at the clock pre-processing section 512E′ relating to the present embodiment, in a state of being interposed between, on the one hand, the output end of the oscillator 512A which outputs the clock signal, and, the CPU 512D and the ones of the input ends of the four 2-input, 1-output AND gates 512E1 through 512E4. Accordingly, the clock signal whose frequency has been multiplied by two is inputted to the CPU 512D and the one input ends of the AND gates 512E1 through 512E4.

A first output end, which outputs mask data for odd-numbered nozzles which will be described later, of the selector 512F whose input end is connected to the CPU 512D, is directly connected to the other input end of the AND gate 512E1. This first output end of the selector 512F is connected, via the inverter 512E5, to the other input end of the AND gate 512E3. Further, a second output end, which outputs mask data for even-numbered nozzles which will be described later, of the selector 512F is directly connected to the other input end of the AND gate 512E2. This second output end of the selector 512F is connected, via the inverter 512E6, to the other input end of the AND gate 512E4. Moreover, the input ends of the selectors 512G are individually connected to the respective output ends, of the print data for the respective driving ICs 16, of the CPU 512D.

At the CPU 512D relating to the present embodiment, composite mask data is outputted to the selector 512F without being classified into mask data for odd-numbered nozzles and mask data for even-numbered nozzles. The selector 512F sorts the composite mask data inputted from the CPU 512D into mask data for odd-numbered nozzles and mask data for even-numbered nozzles, and outputs the data.

The output end of the AND gate 512E1 supplies the clock signal to the shift register 42 of the odd-numbered nozzle corresponding portion 17A of the driving IC 16A1. The output end of the AND gate 512E2 supplies the clock signal to the shift register 42 of the even-numbered nozzle corresponding portion 17B of the driving IC 16A1. The output end of the AND gate 512E3 supplies the clock signal to the shift register 42 of the odd-numbered nozzle corresponding portion 17A of the driving IC 16B1. The output end of the AND gate 512E4 supplies the clock signal to the shift register 42 of the even-numbered nozzle corresponding portion 17B of the driving IC 16B1. This is the same as the controller 512 relating to the above-described third embodiment.

The CPU 512D reads-out the needed mask data from the memory 512B, and prepares the composite mask data on the basis thereof. The CPU 512D synchronizes the composite mask data with the 2× frequency clock signal which is inputted from the frequency multiplier 512E7, and serially outputs the composite mask data to the selector 512F in a state in which the composite mask data is synchronized with the input timings of the print data to the shift registers 42 of the driving ICs 16. In accordance therewith, the mask data for odd-numbered nozzles is outputted from the selector 512F to the AND gate 512E1 and the inverter 512E5, and the mask data for even-numbered nozzles is outputted from the selector 512F to the AND gate 512E2 and the inverter 512E6. Due to this operation, of the clock signals inputted to the corresponding driving ICs 16 from the AND gate 512E1 through the AND gate 512E4, only the signals corresponding to the input timings, to the shift register 42, of the print data which drives the ejector group 534 which is the object of driving of that driving IC 16 are made valid, and the signals corresponding to the input timings, to the shift register 42, of the other print data are made invalid. Accordingly, at each driving IC 16, the driving waveform which drives only the ejector group 534 which is the object of driving of that IC 16, is generated, and only that ejector group 534 is driven.

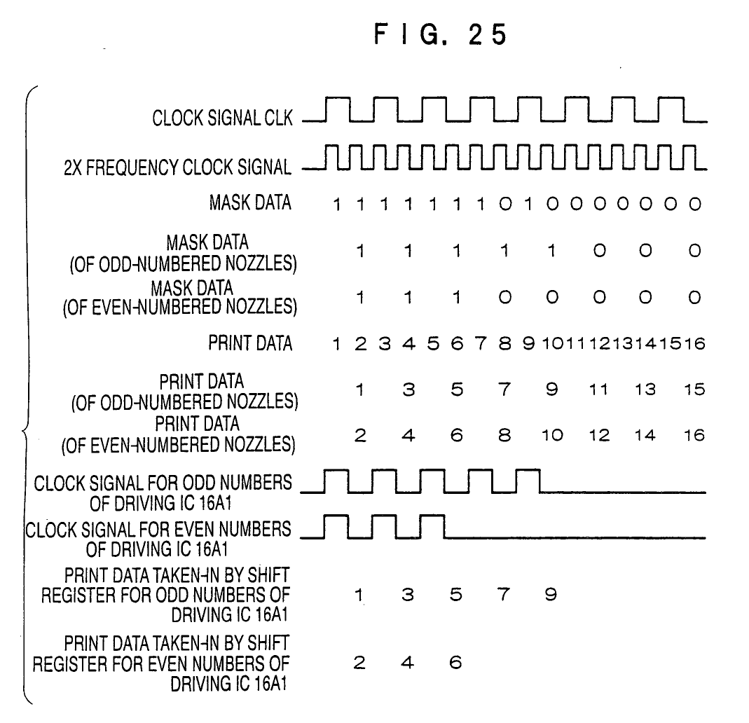

Next, with reference to FIG. 25, the portion relating to the driving IC 16A1 will be described as a concrete example of the generated states of the clock signals supplied to the respective driving ICs 16 at the controller 512 and the states of the print data taken-in by the respective driving ICs 16.

As shown in FIG. 25, at the controller 512, the clock signal whose frequency has been doubled by the frequency multiplier 512E7 (i.e., the 2× frequency clock signal) is inputted to the CPU 512D and to one input end of each of the AND gates 512E1 through 512E4.

At the time when printing is carried out, the CPU 512D reads-out the mask data stored in the memory 512B, and combines the mask data corresponding to the driving IC 16A1 and the inverted data of the mask data corresponding to the driving IC 16B1 so as to prepare the composite mask data (here, ‘1, 1, 1, 1, 1, 1, 0, 1, 0, 0, 0, 0, 0, 0, 0’), and serially outputs the composite mask data to the selector 512F. In accordance therewith, the selector 512F serially outputs mask data for odd-numbered nozzles (here, ‘1, 1, 1, 1, 1, 0, 0, 0’) to the AND gate 512E1 and the inverter 512E5, and serially outputs mask data for even-numbered nozzles (here, ‘1, 1, 1, 0, 0, 0, 0, 0’) to the AND gate 512E2 and the inverter 512E6.

In this way, as shown in FIG. 25, the clock signal outputted from the AND gate 512E1 to the shift register 42 of the odd-numbered nozzle corresponding portion 17A of the driving IC 16A1 is in a state in which the sixth through eighth pulses are eliminated (a low-level state), and the clock signal outputted from the AND gate 512E2 to the shift register 42 of the even-numbered nozzle corresponding portion 17B of the driving IC 16A1 is in a state in which the fourth through the eighth pulses are eliminated (a low-level state).

At this time, the CPU 512D serially inputs, to the corresponding selector 512G, the print data outputted to the driving IC 16A1 (the print data driving all of the ejectors 32 which are objects of driving of both the driving IC 16A1 and the driving IC 16B1). As a result, from that selector 512G to the driving IC 16A1, the print data corresponding to the odd-numbered nozzles (‘1, 3, 5, 7, 9, 11, 13, 15’ in FIG. 25) are serially inputted to the odd-numbered nozzle corresponding portion 17A, and the print data corresponding to the even-numbered nozzles (‘2, 4, 6, 8, 10, 12, 14, 16’ in FIG. 25) are serially inputted to the even-numbered nozzle corresponding portion 17B.

As a result, the print data, which is taken-in by the serial registers 42 of the odd-numbered nozzle corresponding portion 17A and the even-numbered nozzle corresponding portion 17B of the driving IC 16A1, is only data which drives the ejectors 32 which are the objects of driving thereof.

Accordingly, at the odd-numbered nozzle corresponding portion 17A and the even-numbered nozzle corresponding portion 17B of the driving IC 16A1, a driving waveform which drives only the ejector group 534 which is the object of driving thereof, is generated, and only that ejector group 534 is driven.

Here, description has been given focusing on the driving IC 16A1, but the operation is the same for the other driving ICs 16 as well.

In the present embodiment as well, effects which are similar to those of the above-described third embodiment can be exhibited.

### Fifth Embodiment

In the present fifth embodiment, explanation is given of an example of a case in which the object of driving is the inkjet recording head 514 which is provided with the head units 515, where two of the head units 515 overlap partial regions at the end portions of the ejector group 534. The structure of the inkjet recording device 510 relating to the present fifth embodiment is similar to that of the inkjet recording device 510 relating to the above-described second embodiment, except for the structures of the inkjet recording head 514 and the controller 512. Therefore, here, the structures of the inkjet recording head 514 and the controller 512 relating to the present fifth embodiment will be described first.

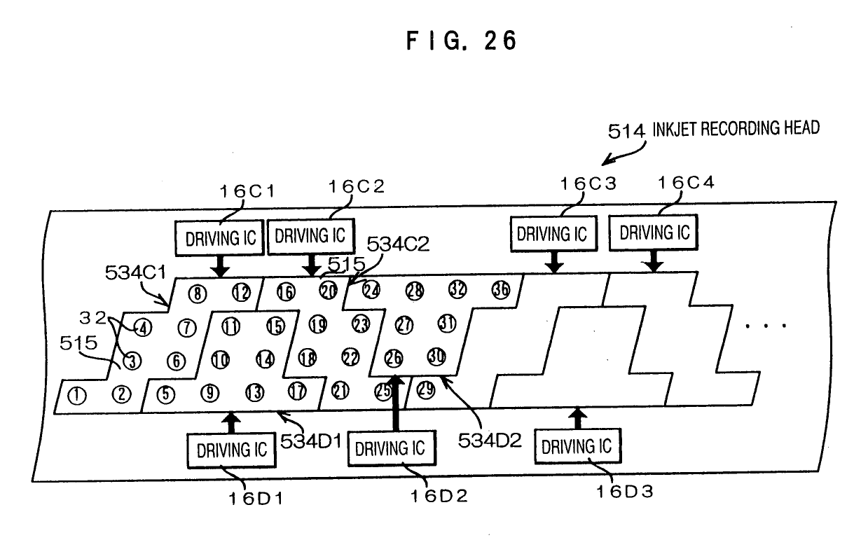

First, the structure of the inkjet recording head 514 relating to the present fifth embodiment will be described with reference to FIG. 26. FIG. 26 is a plan view showing the schematic structure of the inkjet recording head 514 relating to the present fifth embodiment.

As shown in FIG. 26, at the inkjet recording head 514 relating to the present fifth embodiment, each of ejector groups 534C1, 534D1, 534C2, 534D2, . . . , which is structured by the plural ejectors 32 being arranged two-dimensionally, is a unit structure. The plural unit structures are disposed, with respect to a predetermined one direction (the longitudinal direction of the inkjet recording head 514), in a state in which a partial region of at least one end portion of its own ejector group and a partial region of an end portion of the ejector group of an adjacent unit structure, overlap one another in the direction orthogonal to the aforementioned one direction (i.e., in the short side direction of the inkjet recording head 514).

The driving ICs 16C1, 16D1, 16C2, 16D2 . . . are provided individually in a one-to-one correspondence with the ejector groups 534C1, 534D1, 534C2, 534D2, . . . . The ejector group and the corresponding driving IC are electrically connected by a connecting wire (not shown). Hereinafter, the ejector groups 534C1, 534D1, 534C2, 534D2, . . . may be abbreviated as “the ejector group 534”, other than in cases of designating a specific ejector group. Further, hereinafter, the driving ICs 16C1, 16D1, 16C2, 16D2 . . . may be abbreviated as “the driving IC 16”, other than in cases of designating a specific driving IC.

By combining two of the ejector groups 534 relating to the present embodiment, there is structured, as a unit part, the head unit 515 whose outer peripheral configuration is a trapezoidal configuration as seen in plan view, and in which partial regions of the end portions at the sides where the ejector groups are combined overlap one another in the direction orthogonal to the direction in which the ejector groups are combined. In the inkjet recording head 514 relating to the present embodiment, plural pairs of the head units 515, which are combined as described above, are lined-up in the longitudinal direction of the inkjet recording head 514. In this state, the head units 515, except for the head units 515 positioned at the both end portions, are in a state in which partial regions of the ejector groups 534 at the head units 515 adjacent at the right and the left overlap its own ejector groups 534 in the short side direction of the inkjet recording head 514.

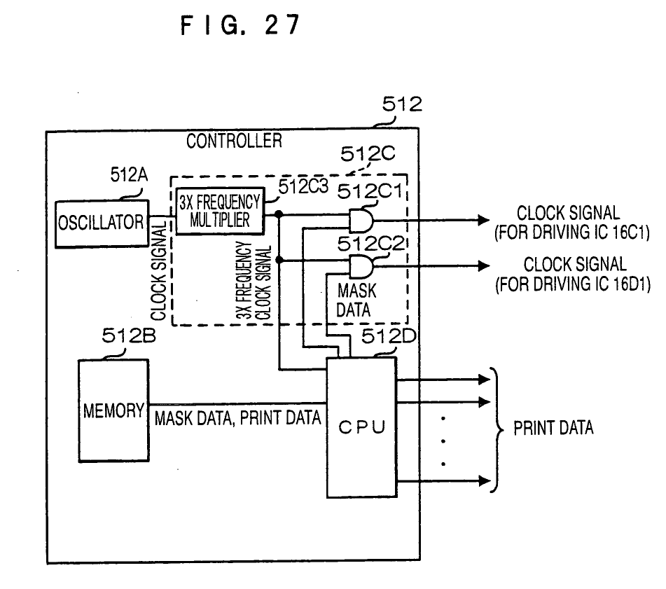

Next, the structure of the controller 512 relating to the present fifth embodiment will be described with reference to FIG. 27. Note that, in FIG. 27, structural elements that are similar to those in FIG. 18 are denoted by the same reference numerals as in FIG. 18, and description thereof is omitted.

As shown in FIG. 27, the controller 512 relating to the present embodiment differs from the controller 512 relating to the above-described second embodiment only with regard to the point that a clock pre-processing section 512C′ having a 3× frequency multiplier 512C3′ is used instead of the clock pre-processing section 512C. Note that, in order to avoid complication, in FIG. 27, only the portions relating to the driving IC 16C1 and the driving IC 16D1 are shown as the clock pre-processing section 512C′, and hereinafter, description will be mainly be given of these portions. However, the same holds for the portions relating to the other driving ICs 16 as well.

The clock pre-processing section 512C′ relating to the present embodiment has the 2-input, 1-output AND gates 512C1, 512C2 and the 3× frequency multiplier 512C3′. The output end, which outputs the clock signal, of the oscillator 512A is connected to the input end of the 3× frequency multiplier 512C3′. At the 3× frequency multiplier 512C3′, the frequency of the inputted clock signal is multiplied by three and outputted. The output end, for the clock signal whose frequency has been multiplied by three, of the 3× frequency multiplier 512C3′ is connected to the CPU 512D and to one input end of each of the AND gates 512C1, 512C2. The clock signal, whose frequency has been multiplied by three (hereinafter called the “3× frequency clock signal”), is inputted to the respective one input ends of the AND gates 512C1, 512C2 and to the CPU 512D.

The CPU 512D is directly connected to the other input ends of the AND gates 512C1, 512C2. The output end of the AND gate 512C1 supplies the clock signal to the driving IC 16C1, and the output end of the AND gate 512C2 supplies the clock signal to the driving IC 16D1.

Mask data is stored in advance in the memory 512B of the present fifth embodiment as well. Of the clock signals inputted to the driving ICs 16, the mask data makes valid only the pulses corresponding to the input timings, to the shift registers 42, of the print data by which the driving ICs 16 drive the ejector groups 534 which are the objects of driving, and makes invalid the pulses corresponding to the input timings, to the shift registers 42, of the other print data.

Namely, the controller 512 relating to the present fifth embodiment divides all of the print data of the image which is the object of recording into groups of data, which data are such that the image to be recorded is substantially rectangular and are of the same number as the number of ejectors (here, eight) of one ejector group 534. The controller 512 serially inputs, to each of the driving ICs 16 and as print data, only the print data of the divisional group in which is included the print data which drives the ejectors 32 disposed at the corresponding head unit 515. As a result, for example, the print data which drives the first through sixteenth ejectors 32 shown in FIG. 26 is inputted to the driving IC 16C1, and the print data which drives the first through twenty-fourth ejectors 32 is inputted to the driving IC 16D1.

The memory 512B of the controller 512 relating to the present embodiment stores, in advance, mask data which corresponds to the respective head units 515 and which is structured as binary data indicating that, with respect to all of the print data included in the divisional group which contains the most print data for driving the ejectors 32 disposed at the corresponding head unit 515, the print data which drives the ejectors 32 disposed at that head unit 515 are not masked, and the print data other than that print data are masked. Note that, in the present embodiment as well, ‘1’ is used as the value expressing do not mask, and ‘0’ is used as the value expressing mask. In the inkjet recording head 514 shown in FIG. 26, for example, ‘1, 1, 1, 1, 0, 1, 1, 1’ is stored in the memory 512B as mask data corresponding to the driving IC 16C1, and ‘1, 1, 1, 0, 1, 1, 1, 0’ is stored in the memory 512B as mask data corresponding to the driving IC 16D1.

The controller 512 masks the print data inputted to each of the driving ICs 16, by using composite mask data which combines: mask data corresponding to the head unit 515 which is the object of driving of the driving IC 16 which is the object of input of the print data; and inverted data of the mask data corresponding to the head unit 515 in which a partial region of the end portion of the ejector group 534 overlaps, in the short side direction of the inkjet recording head 514, a partial region of the end portion of the ejector group 534 of the aforementioned head unit 515. As a result, at the inkjet recording head 514 shown in FIG. 26, ‘0, 0, 0, 0, 1, 0, 0, 0, 1, 1, 1, 0, 1, 1, 1, 0, 1, 1, 1, 0, 0, 0, 0, 0, 0, 0’ is prepared and used as the composite mask data which masks the print data inputted to the driving IC 16D1 for example.

The CPU 512D reads-out the needed mask data from the memory 512B, and prepares the composite mask data on the basis thereof. The CPU 512D synchronizes the composite mask data with the clock signal, which is inputted from the 3× frequency multiplier 512C3′ and whose frequency is trebled, and serially outputs the prepared composite mask data to the AND gate 512C1 and the AND gate 512C2 in a state in which the composite mask data is synchronized with the input timings of the print data to the shift registers 42 of the driving ICs 16. In this way, of the clock signals inputted to the corresponding driving ICs 16 from the AND gate 512C1 and the AND gate 512C2, only the signals corresponding to the input timings, to the shift registers 42, of the print data which drive the ejector groups 534 which are the objects of driving of those driving ICs 16 are made valid, and the signals corresponding to the input timings, to the shift registers 42, of the other print data are made invalid. Accordingly, at each driving IC 16, a driving waveform which drives only the ejector group 534 which is the object of driving of that driving IC 16, is generated, and only that ejector group 534 is driven.

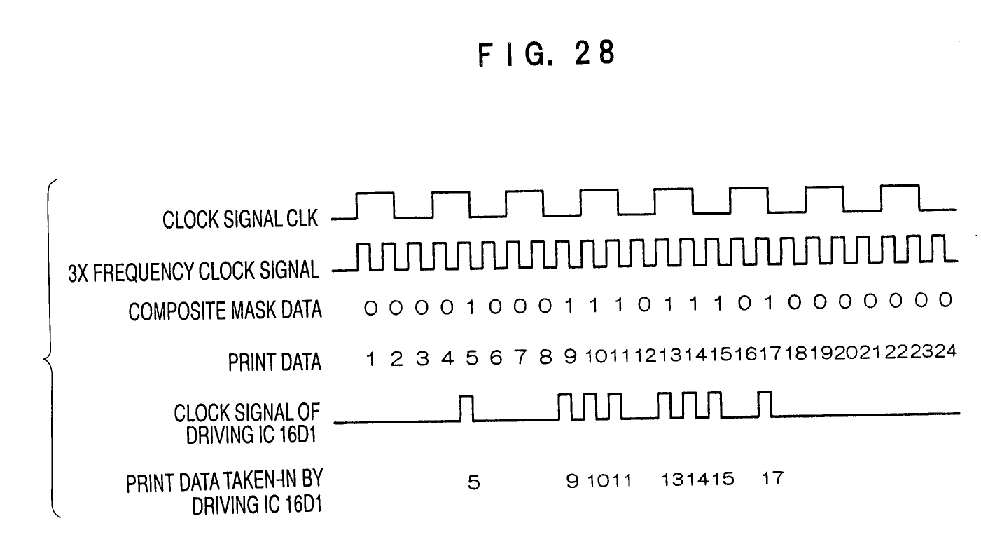

Next, with reference to FIG. 28, the portion relating to the driving IC 16D1 will be described as a concrete example of the generated state of the clock signal supplied to each driving IC 16 at the controller 512 and the state of the print data taken-in by the respective driving ICs 16.

As shown in FIG. 28, at the controller 512, the 3× frequency clock signal, which is obtained by multiplying by three the frequency of the clock signal CLK generated by the oscillator 512A, is generated, and is inputted to one input end of the AND gate 512C2.

At the time when printing is carried out, the CPU 512D reads-out the mask data stored in the memory 512B, and combines the inverted data of the mask data corresponding to the driving IC 16C1, the mask data corresponding to the driving IC 16D1, and the inverted data of the mask data corresponding to the driving IC 16C2, so as to prepare the composite mask data (here, ‘0, 0, 0, 0, 1, 0, 0, 0, 1, 1, 1, 0, 1, 1, 1, 0, 1, 0, 0, 0, 0, 0, 0, 0’), and serially outputs the prepared composite mask data to the AND gate 512C2.

In this way, as shown in FIG. 28, the clock signal outputted from the AND gate 512C2 to the driving IC 16D1 is in a state in which the first through fourth, sixth through eighth, twelfth, sixteenth, and eighteenth through twenty-fourth pulses are eliminated (a low-level state).

As a result, the print data taken-in by the shift register 42 of the driving IC 16D1 only drives the ejectors 32 which are the objects of driving thereof.

Accordingly, at the driving IC 16D1, a driving waveform which drives only the ejector group 534 which is the object of driving of that IC 16D1, is generated, and only that ejector group 534 is driven.

Here, description has been given focusing on the driving IC 16D1, but the operation is the same for the other driving ICs 16 as well.

As described above in detail, the present embodiment can exhibit the effects of the above-described second embodiment, other than the effects relating to the 2× frequency clock signal. Further, by obtaining the logical product of the composite mask data and the 3× clock signal obtained by trebling the frequency of the clock signal, a clock signal after thinning is generated, and the print data is inputted to the corresponding driving circuit (here, the driving IC 16) in a state of being synchronized with this post-thinning clock signal. Therefore, it is possible to realize a printing speed of the same extent as a case supposing the inputting, to each driving circuit, of print data corresponding only to the ejectors which are driven by that driving circuit.

The present fifth embodiment describes a case in which, when driving the inkjet recording head provided with unit structures such that two of the unit structures overlap partial regions at end portions of an ejector group, a post-thinning clock signal is generated by obtaining the logical product of composite mask data and a 3× frequency clock signal obtained by trebling the frequency of the clock signal, and print data is inputted to the corresponding driving circuit in a state of being synchronized with the post-thinning clock signal. However, the present invention is not limited to the same, and may be a form in which, for example, the composite mask data is classified into three systems which are set in advance, and by obtaining in parallel the logical products of the clock signals and the composite mask data of these three groups after the classification, post-thinning clock signals are generated in parallel for the three systems. The print data is classified into these three systems, and the three groups of the post-classification print data are inputted to the corresponding driving circuit in a state of being synchronized with the corresponding clock signal among the clock signals for the three systems.

As an embodiment of such a case, the example can be given of a form in which, when the inkjet recording head 514 shown in FIG. 26 is the object of driving, the ejector groups 534 of each head unit 515 are classified, in accordance with some standard, into three groups (e.g., three groups which are three ejectors, three ejectors, and two ejectors in that order from the longitudinal direction left end of the ink jet recording head 14). Three systems of the structure, which is formed from the shift register 42, the latch circuit 44, the selector 46, the level shifter 48, and the driving waveform generating circuit 50, are provided at the driving IC 16 in correspondence with the respective groups. For each of the systems, in the same way as in the above-described third embodiment, a clock signal to be inputted to each shift register is generated.

In this case as well, it is possible to realize a printing speed of the same extent as a case supposing the inputting, to each driving circuit, of the print data corresponding only to the ejectors which are driven by that driving circuit.

In the above-described second through fifth embodiments, description is given of a case in which the clock pre-processing section is provided at the controller 512. However, the present invention is not limited to the same, and for example, can be a form in which the clock pre-processing section is provided at each of the driving ICs 16. As an embodiment of such a case, the example can be given of a form in which a memory, which stores mask data which masks the print data not used at that driving IC 16, is provided at each driving IC 16, the clock signal generated by the oscillator 512A is inputted from the controller 512 to the respective driving ICs 16, and in the same way as in the second through fifth embodiments, these clock signals are inputted to the shift registers 42 in states of being masked by the clock pre-processing sections. In this case, similar effects as those of the second through fifth embodiments can be exhibited.

The second through fifth embodiments describe cases in which the driving circuit of the present invention is structured as an IC. However, the present invention is not limited to the same, and may be a form in which the driving circuit is structured as an electronic circuit using electronic elements. Similar effects as those of the second through fifth embodiments can be exhibited in this case as well.

Further, in the second through fifth embodiments, cases are described in which the driving ICs 16 are provided at the inkjet recording head 514, but the present invention is not limited to the same. For example, a form can be used in which the respective driving ICs 16 are structured integrally with the controller 512, or a form can be used in which the controller 512 and the inkjet recording head 514 are provided as separate bodies. In this case, the size of the inkjet recording head 514 can be made to be more compact.

Moreover, the structures of the respective portions of the inkjet recording device 510 described in the second through fifth embodiments, and the forms of the driving waveforms, the waveform signals and the like (see FIGS. 16 through 18, and FIGS. 20 through 28) are examples, and it goes without saying that appropriate modifications are possible within a scope which does not deviate from the gist of the present invention.

The flow of the processings of the printing processing program described in the second embodiment (see FIG. 19) is an example, and appropriate modifications can be made within a scope which does not deviate from the gist of the present invention.

The above embodiments describe, as examples, cases in which ink is used as the liquid drop. However, the present invention is not limited to the same, and instead of ink, a reaction liquid can be used for example. Specifically, by blending a drop of ink and a drop of a reaction liquid on the recording medium, the image quality can be further improved. Therefore, when ejecting drops of a reaction liquid at liquid drop ejectors, the present invention can be applied in the same way as described above. The present invention can also be applied in the same way as described above to the application of an oriented film forming material of a liquid crystal display element, the application of flux, the application of an adhesive, the application of a wiring material of a printed board, and the like.

The present invention may further comprise a masking section which, of the print data inputted to the respective driving circuits by the data inputting section, masks the print data driving the ejectors which are included in the mutually-overlapping region of the ejector group adjacent to the corresponding ejector group.

In particular, the masking section may carry out masking by thinning-out signals corresponding to print data which drive the ejectors which are included in the mutually-overlapping region of the adjacent ejector group, of the clock signal expressing timing of inputting the print data to the driving circuit.

Further, in the present invention, a configuration of a region where the ejector group is disposed may be at least one of trapezoidal and triangular.

The data inputting section of the present invention may divide all of the print data of an image which is an object of recording into groups of data where the data of each group are such that the image to be recorded is substantially rectangular and are of the same number as a number of ejectors in one ejector group, and the data inputting section may serially input, to each of plural driving circuits and as the print data, only print data of a divisional group which includes print data driving ejectors disposed at the corresponding unit structure.

The present invention may further comprise a memory section storing in advance mask data which corresponds respectively to plural unit structures, and which is structured as binary data expressing that, of all of the print data included in the divisional group containing the most print data driving the ejectors disposed in the corresponding unit structure, print data driving the ejectors disposed at that unit structure are not to be masked, and print data other than that print data are to be masked. The masking section may carry out masking of the print data inputted to the respective driving circuits, by using composite mask data which combines: mask data corresponding to a unit structure which is an object of driving of a driving circuit which is an object of input of print data, and inverted data of mask data corresponding to a unit structure at which a partial region of an end portion of an ejector group overlaps a partial region of an end portion of an ejector group of that unit structure, in the direction orthogonal to the one direction.

Examples of the memory section include semiconductor storage elements such as a RAM (Random Access Memory), an EEPROM (Electrically Erasable and Programmable Read Only Memory), a Flash EEPROM, and the like; portable recording media such as SmartMedia™, xD-Picture Card, CompactFlash, an ATA (AT Attachment) card, a microdrive, a floppy disk, a CD-R (Compact Disc-Recordable), a CD-RW (Compact Disc-ReWritable), a magnetooptical disk, and the like; fixed recording media such as a hard disk, and the like; and external storage devices provided at, for example, a server computer connected to a network, and the like.

The present invention may further comprise a clock signal generating section generating a clock signal of a predetermined frequency. The data inputting section may input the print data to the corresponding driving circuit in a state in which the print data is synchronized with the clock signal, and the masking section may carry out masking by thinning-out, by using the composite mask data, pulses of the clock signal which correspond to input timings of print data which are objects of masking.

In particular, when driving a recording head provided with only unit structures in which a partial region of an end portion of the ejector group mutually overlaps one unit structure, the masking section may generate a post-thinning clock signal, by obtaining a logical product of the composite mask data and a 2× frequency clock signal obtained by multiplying a frequency of the clock signal by two, and the data inputting section may input the print data to the corresponding driving circuit in a state in which the print data is synchronized with the post-thinning clock signal.

Further, when driving a recording head provided with only unit structures in which a partial region of an end portion of the ejector group mutually overlaps one unit structure, the masking section may classify the composite mask data into two predetermined systems, and by obtaining in parallel logical products of the clock signal and the two groups of post-classification composite mask data, may generate in parallel post-thinning clock signals for the two systems, and the data inputting section may classify the print data into the two systems, and input the two groups of post-classification print data to the corresponding driving circuits in states in which the two groups of post-classification print data are synchronized with the corresponding clock signals of the clock signals for the two systems generated by the masking section.

Moreover, when driving a recording head provided with unit structures in which partial regions of end portions of the ejector groups mutually overlap two unit structures, the masking section may generate a post-thinning clock signal, by obtaining a logical product of the composite mask data and a 3× frequency clock signal obtained by multiplying a frequency of the clock signal by three, and the data inputting section may input the print data to the corresponding driving circuit in a state in which the print data is synchronized with the post-thinning clock signal.

When driving a recording head provided with unit structures in which partial regions of end portions of the ejector groups mutually overlap two unit structures, the masking section may classify the composite mask data into three predetermined systems, and by obtaining in parallel logical products of the clock signal and the three groups of post-classification composite mask data, may generate in parallel post-thinning clock signals for the three systems, and the data inputting section may classify the print data into the three systems, and input the three groups of post-classification print data to the corresponding driving circuits in states in which the three groups of post-classification print data are synchronized with the corresponding clock signals of the clock signals for the three systems generated by the masking section.

In the present invention, the recording head may be provided so as to correspond to an entire width of a recording medium which is a destination of ejecting of the liquid drops by the ejector groups.

In the present invention, the ejectors may eject the liquid drops by driving of piezoelectric elements.

In the present invention, the print data may be data which set amounts of the liquid drops ejected by the ejectors.

In the present invention, a print data amount inputted to each of plural driving circuits may be an amount which is greater than or equal to a print data amount which the corresponding driving circuit can hold, and which is less than or equal to two times the print data amount which the corresponding driving circuit can hold.

In the present invention, numbers of ejectors disposed at plural ejector groups may be the same, and a print data amount inputted to driving circuits of a number which is greater than or equal to one and which is less than a number of the driving circuits, may be different than a print data amount inputted to other driving circuits.

What is claimed is:

1. A driving device of a recording head in which plural ejector groups, at which plural ejectors which respectively eject liquid drops are disposed two-dimensionally, are disposed, with respect to a predetermined one direction, in a state in which a partial region of at least one end portion of each of the ejector groups, and a partial region of an end portion of an adjacent ejector group, mutually overlap one another in a direction orthogonal to the one direction, the driving device comprising:
plural driving circuits provided so as to correspond to the ejector groups respectively, the driving circuits driving the corresponding ejector groups on the basis of inputted print data; and
a data inputting section inputting, to each of plural driving circuits, print data for driving the corresponding ejector group, in a state in which the print data driving the corresponding ejector group includes only print data driving ejectors which are included in a mutually-overlapping region of an ejector group adjacent to that ejector group.

2. The driving device of a recording head of claim 1, further comprising a masking section which, of the print data inputted to the respective driving circuits by the data inputting section, masks the print data driving the ejectors which are included in the mutually-overlapping region of the ejector group adjacent to the corresponding ejector group.

3. The driving device of a recording head of claim 2, wherein the masking section carries out masking by thinning-out signals corresponding to print data which drive the ejectors which are included in the mutually-overlapping region of the adjacent ejector groups, of the clock signal expressing timing of inputting the print data to the driving circuit.

4. The driving device of a recording head of claim 1, wherein a configuration of a region where the ejector group is disposed is at least one of trapezoidal shape and triangular shape.

5. A driving device of a recording head in which plural unit structures, which have ejector groups at which plural ejectors which respectively eject liquid drops are disposed two-dimensionally, are disposed, with respect to a predetermined one direction, in a state in which a partial region of at least one end portion of the ejector group, and a partial region of an end portion of an ejector group of an adjacent unit structure, mutually overlap one another in a direction orthogonal to the one direction, the driving device comprising:
plural driving circuits provided so as to correspond to the unit structures respectively, the driving circuits driving the ejector groups of the corresponding unit structures on the basis of inputted print data;
a data inputting section serially inputting, to each of plural driving circuits and as the print data, print data which is such that an image to be recorded is substantially rectangular and which includes print data driving all of the ejectors disposed at the corresponding unit structure; and
a masking section which, of the print data inputted to the respective driving circuits by the data inputting section, masks the print data driving ejectors other than ejectors disposed at the corresponding unit structure.

6. The driving device of a recording head of claim 5, wherein the data inputting section divides all of the print data of an image which is an object of recording into groups of data where the data of each group are such that the image to be recorded is substantially rectangular and are of the same number as a number of ejectors in one ejector group, and the data inputting section serially inputs, to each of plural driving circuits and as the print data, only print data of a divisional group which includes print data driving ejectors disposed at the corresponding unit structure.

7. The driving device of a recording head of claim 6, further comprising a memory section storing in advance mask data which corresponds respectively to plural unit structures, and which is structured as binary data expressing that, of all of the print data included in the divisional group containing the most print data driving the ejectors disposed in the corresponding unit structure, print data driving the ejectors disposed at that unit structure are not to be masked, and print data other than that print data are to be masked,
wherein the masking section carries out masking of the print data inputted to the respective driving circuits, by using composite mask data which combines: mask data corresponding to a unit structure which is an object of driving of a driving circuit which is an object of input of print data, and inverted data of mask data corresponding to a unit structure at which a partial region of an end portion of an ejector group overlaps a partial region of an end portion of an ejector group of that unit structure, in the direction orthogonal to the one direction.

8. The driving device of a recording head of claim 7, further comprising a clock signal generating section generating a clock signal of a predetermined frequency,
wherein the data inputting section inputs the print data to the corresponding driving circuit in a state in which the print data is synchronized with the clock signal, and
the masking section carries out masking by thinning-out, by using the composite mask data, pulses of the clock signal which correspond to input timings of print data which are objects of masking.

9. The driving device of a recording head of claim 8, wherein, when driving a recording head provided with only unit structures in which a partial region of an end portion of the ejector group mutually overlaps one unit structure,
the masking section generates a post-thinning clock signal, by obtaining a logical product of the composite mask data and a 2× frequency clock signal obtained by multiplying a frequency of the clock signal by two, and
the data inputting section inputs the print data to the corresponding driving circuit in a state in which the print data is synchronized with the post-thinning clock signal.

10. The driving device of a recording head of claim 8, wherein when driving a recording head provided with only unit structures in which a partial region of an end portion of the ejector group mutually overlaps one unit structure,
the masking section classifies the composite mask data into two predetermined systems, and by obtaining in parallel logical products of the clock signal and the two groups of post-classification composite mask data, generates in parallel post-thinning clock signals for the two systems, and
the data inputting section classifies the print data into the two systems, and inputs the two groups of post-classification print data to the corresponding driving circuits in states in which the two groups of post-classification print data are synchronized with the corresponding clock signals of the clock signals for the two systems generated by the masking section.

11. The driving device of a recording head of claim 8, wherein, when driving a recording head provided with unit structures in which partial regions of end portions of the ejector groups mutually overlap two unit structures,
the masking section generates a post-thinning clock signal, by obtaining a logical product of the composite mask data and a 3× frequency clock signal obtained by multiplying a frequency of the clock signal by three, and
the data inputting section inputs the print data to the corresponding driving circuit in a state in which the print data is synchronized with the post-thinning clock signal.

12. The driving device of a recording head of claim 8, wherein when driving a recording head provided with unit structures in which partial regions of end portions of the ejector groups mutually overlap two unit structures,
the masking section classifies the composite mask data into three predetermined systems, and by obtaining in parallel logical products of the clock signal and the three groups of post-classification composite mask data, generates in parallel post-thinning clock signals for the three systems, and
the data inputting section classifies the print data into the three systems, and inputs the three groups of post-classification print data to the corresponding driving circuits in states in which the three groups of post-classification print data are synchronized with the corresponding clock signals of the clock signals for the three systems generated by the masking section.

13. The driving device of a recording head of claim 1, wherein the recording head is provided so as to correspond to an entire width of a recording medium which is a destination of ejecting of the liquid drops by the ejector groups.

14. The driving device of a recording head of claim 1, wherein the ejectors eject the liquid drops by driving of piezoelectric elements.

15. The driving device of a recording head of claim 1, wherein the print data is data which set amounts of the liquid drops ejected by the ejectors.

16. A driving method of a recording head in which plural ejector groups, at which plural ejectors which respectively eject liquid drops are disposed two-dimensionally, are disposed, with respect to a predetermined one direction, in a state in which a partial region of at least one end portion of each of the ejector groups, and a partial region of an end portion of an adjacent ejector group, mutually overlap one another in a direction orthogonal to the one direction, the driving method comprising:
providing plural driving circuits, which drive corresponding ejector groups on the basis of inputted print data, in correspondence with the respective ejector groups; and
inputting, to each of plural driving circuits, print data for driving the corresponding ejector group, in a state in which the print data driving the corresponding ejector group includes only print data driving ejectors which are included in a mutually-overlapping region of an ejector group adjacent to that ejector group.

17. The driving method of a recording head of claim 16, wherein a print data amount inputted to each of plural driving circuits is an amount which is greater than or equal to a print data amount which the corresponding driving circuit can hold, and which is less than or equal to two times the print data amount which the corresponding driving circuit can hold.

18. The driving method of a recording head of claim 16, wherein numbers of ejectors disposed at plural ejector groups are the same, and
a print data amount inputted to driving circuits of a number which is greater than or equal to one and which is less than a number of the driving circuits, is different than a print data amount inputted to other driving circuits.

19. A driving method of a recording head in which plural unit structures, which have ejector groups at which plural ejectors which respectively eject liquid drops are disposed two-dimensionally, are disposed, with respect to a predetermined one direction, in a state in which a partial region of at least one end portion of the ejector group, and a partial region of an end portion of an ejector group of an adjacent unit structure, mutually overlap one another in a direction orthogonal to the one direction, the driving method comprising:
providing plural driving circuits, which drive ejector groups of corresponding unit structures on the basis of inputted print data, in correspondence with the respective unit structures; and
serially inputting, to each of plural driving circuits and as the print data, print data which is such that an image to be recorded is substantially rectangular and which includes print data driving all of the ejectors disposed at the corresponding unit structure, in a state in which print data, which drives ejectors other than the ejectors disposed at the corresponding unit structure, are masked.
